(19) United States
(12) Patent Application Publication
(10) Pub. No.: US 2026/0161962 A1
(43) Pub. Date: Jun. 11, 2026

(54) SYSTEM, METHOD, AND APPARATUS FOR PREDICTING AND REDUCING PRE-HARVEST AND POST-HARVEST AFLATOXIN CONTAMINATION IN MAIZE USING MACHINE LEARNING

(71) Applicant: MARS, INCORPORATED, Mclean, VA (US)

(72) Inventors: Robert C. BAKER, Mueng Nakhon Ratchasima (TH); Bruce SIMPSON, Slough (GB); Jared L. SHAW, Thompson's Station, TN (US); David GELLIE, Wodonga (AU); Peter MARKWELL, Londonthorpe, Grantham (GB); Guangtao ZHANG, Newark, NJ (US); Abigail STEVENSON, Waltham (GB)

(73) Assignee: MARS, INCORPORATED, Mclean, VA (US)

(21) Appl. No.: 19/123,492

(22) PCT Filed: Oct. 24, 2023
(86) PCT No.: PCT/US2023/035822

§ 371 Date: Apr. 23, 2025

Related U.S. Application Data
(60) Provisional application No. 63/380,900, filed on Oct. 25, 2022.
(60) Provisional application No. 63/490,224, filed on Mar. 14, 2023.

(51) Int. Cl. G06N 5/022

(52) U.S. Cl. CPC G06N 5/022

(57) ABSTRACT

A method for evaluating a decision of processing batches of maize in a selected region is provided. The method includes obtaining meteorological data in time series associated with a selected region, and predicting an amount of A. flavus and aflatoxin contamination in the time series for a plurality of batches of maize using an integrated mechanistic model based on the meteorological data. The integrated mechanistic model can comprise estimated parameters and reference parameters. The estimated parameters can be optimized based on a comparison of a historical measured data set and a historical predicted data set. The method further includes evaluating a decision of processing the batches of maize in the selected region based on the predicted amount of A. flavus and the predicted aflatoxin contamination.

### CROSS-REFERENCE TO RELATED APPLICATIONS

The present application claims priority to U.S. Provisional Patent Application No. 63/490,224, filed on Mar. 14, 2023, and U.S. Provisional Patent Application No. 63/380,900, filed on Oct. 25, 2022, the contents of which are hereby incorporated by reference in their entireties.

### TECHNICAL FIELD

The embodiments described in this disclosure relate to the utilization of computer-implemented models for predicting and reducing fungal and aflatoxin contamination in plants or crops.

### BACKGROUND

An estimated 25% of the crops grown, stored and traded are contaminated with secondary fungal metabolites classed as mycotoxins. Among these mycotoxins, Aflatoxin B1 (AFB1) is one of the most potent human carcinogens. Aflatoxin poisoning can occur directly, via skin contact with contaminated field crops and stored produce, but more commonly through ingestion, causing delayed development in children and severe liver damage linked to hepatitis B and liver cancer. Aspergillus flavus is a major source of aflatoxin. It is a widely distributed, prolific soil saprotroph that is also capable of infecting a wide range of the crops, including cereals, legumes and tree nuts.

Maize is extensively cultivated around the world, with an annual global production exceeding 1 billion metric tons, covering 200 million hectares. While up to 85% is traded for livestock feed, industrial products and biofuels among developed economies, it remains the primary income source and an important component for nutrition in the diets of many people in countries across Sub-Saharan Africa, Latin America, and Asia. Moreover, producers and consumers from low- and middle-income countries in tropical and sub-tropical regions are most at risk to mycotoxin exposure. Climatic conditions are optimal for the development of aflatoxins in these regions and infrastructure and access to new technologies for storing, transporting, and processing grain are often lacking.

Maize is susceptible to infection and colonization by A. flavus and aflatoxin production during the pre-harvest and post-harvest phases of crop growth and storage. Spores of A. flavus, in the form of wind-dispersed conidia released from mycelium and sclerotia on soil surfaces, infect the developing inflorescences of maize. The fungus invades the grain, producing aflatoxin. Fungal growth and aflatoxin production are strongly influenced throughout the pre- and post-harvest phases by ambient temperature and moisture availability.

### SUMMARY OF PARTICULAR EMBODIMENTS

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages, and in accordance with the purpose of the disclosed subject matter, as embodied and broadly described, the disclosed subject matter presents systems, methods, and apparatuses that can be used to collect, receive and/or analyze data. For example, certain non-limiting embodiments can be used to predict pre- and post-harvest aflatoxin contamination in crops, e.g., maize.

In certain non-limiting embodiments, the disclosure describes a method for determining aflatoxin risk to crops, where levels of mycotoxin contamination in this widely traded commodity are of increasing global concern. Specifically, the embodiments disclosed herein integrate meteorologically driven epidemiological models for pre- and post-harvest dynamics A. flavus as a tool to predict, review and manage risks along the entire maize supply chain from farm to factory gate. The embodiments disclosed herein also introduce functions to simulate disease management scenarios including post-harvest drying and filtering. Although this disclosure describes an aflatoxin risk predication tool to help monitor mycotoxin risks in maize, the aflatoxin risk predication tool can be applied to any suitable crops such as sorghum, wheat, quinoa and peanuts.

In certain non-limiting embodiments, the disclosure describes a method. The method includes obtaining meteorological data in time series associated with a selected region, and predicting an amount of A. flavus and aflatoxin contamination in the time series for a plurality of batches of maize using an integrated mechanistic model based on the meteorological data. The integrated mechanistic model can comprise estimated parameters and reference parameters. The estimated parameters can be optimized based on a comparison of a historical measured data set and a historical predicted data set. The method further includes evaluating a decision of processing the batches of maize in the selected region based on the predicted amount of A. flavus and the predicted aflatoxin contamination.

In certain non-limiting embodiments, one or more computing systems can obtain meteorological data in time series associated with a selected region. The computing systems can predict an amount of A. flavus and aflatoxin contamination in the time series for a plurality of batches of maize using an integrated mechanistic model based on the meteorological data. In one embodiment, the integrated mechanistic model can comprise estimated parameters and reference parameters. The estimated parameters can be optimized based on a comparison of a historical measured data set and a historical predicted data set. The computing systems can further evaluate a decision of processing the batches of maize in the selected region based on the predicted amount of A. flavus and the predicted aflatoxin contamination.

In certain non-limiting embodiments, one or more computer-readable non-transitory storage media embodying software is operable when executed to obtain meteorological data in time series associated with a selected region. The computer-readable non-transitory storage media embodying software is further operable when executed to predict an amount of A. flavus and aflatoxin contamination in the time series for a plurality of batches of maize using an integrated mechanistic model based on the meteorological data, wherein the integrated mechanistic model comprises estimated parameters and reference parameters, wherein the estimated parameters being optimized based on a comparison of a historical measured data set and a historical predicted data set. The computer-readable non-transitory storage media embodying software is further operable when executed to evaluate a decision of processing the batches of maize in the selected region based on the predicted amount of A. flavus and the predicted aflatoxin contamination.

In certain non-limiting embodiments, a system can comprise one or more processors and a non-transitory memory coupled to the processors comprising instructions executable by the processors. The processors are operable when executing the instructions to obtain meteorological data in time series associated with a selected region. The processors are further operable when executing the instructions to predict an amount of A. flavus and aflatoxin contamination in the time series for a plurality of batches of maize using an integrated mechanistic model based on the meteorological data, wherein the integrated mechanistic model comprises estimated parameters and reference parameters, wherein the estimated parameters being optimized based on a comparison of a historical measured data set and a historical predicted data set. The processors are further operable when executing the instructions to evaluate a decision of processing the batches of maize in the selected region based on the predicted amount of A. flavus and the predicted aflatoxin contamination. Furthermore, the disclosed embodiments of the methods, computer readable non-transitory storage media, and systems can have further non-limiting features as described below.

In certain non-limiting embodiments, the integrated mechanistic model can comprise mechanisms associated with a pre-harvest stage, a harvest processing stage, and a post-harvest stage.

In certain non-limiting embodiments, the meteorological data can comprise temperature data, humidity data and rainfall data.

In certain non-limiting embodiments, the meteorological data can comprise a resolution of three hourly temporal and ten kilometers. In one feature, the temporal data can be linearly interpolated to 1-hourly temporal resolution.

In certain non-limiting embodiments, the historical measured data set can comprise a first dataset being used for parameterizing the integrated mechanistic model, and a second dataset being used for validating the integrated the integrated mechanistic model.

In certain non-limiting embodiments, the estimated parameters can comprise a sporulation rate, a pre-harvest A. flavus growth rate, a pre-harvest Aflatoxin production rate, a drying protection period, a post-harvest A. flavus growth rate, and a post-harvest Aflatoxin production rate.

In certain non-limiting embodiments, the disclosure describes a method executed by one or more computing system. The method includes obtaining input data, the input data including at least future meteorological data associated with a selected region. The method further includes predicting, based on the input data, an amount of aflatoxin contamination for a future time point for a plurality of batches of crops using a predicting model, the predicting model including parameters that are optimized based on a comparison of a historical measured data set and a historical predicted data set. Further, the method includes selecting a mitigating action for reducing the amount of aflatoxin contamination and performing the mitigating action.

In certain non-limiting embodiments, the selecting of the mitigating action for reducing the amount aflatoxin contamination is determined by minimizing a cost function.

In certain non-limiting embodiments, the cost function is selected such that the amount of aflatoxin contamination is reduced below a selected threshold value at the future time point.

In certain non-limiting embodiments, the cost function further includes a cost of performing the mitigating action.

In certain non-limiting embodiments, the cost function further includes a benefit for supporting agriculture at a particular region.

In certain non-limiting embodiments, the mitigating action include one of: filtering, drying or bagging.

In certain non-limiting embodiments, the input data further includes farm-related data.

In certain non-limiting embodiments, the mitigating action is a first mitigating action. The method further comprising selecting a second mitigating action resulting in a further reduction of the amount of aflatoxin contamination.

In certain non-limiting embodiments, the disclosure describes a method executed by one or more computing system. The method includes obtaining input data, the input data including a first set of future meteorological data associated with a first selected region; and a second set of future meteorological data associated with a second selected region. Further, the method includes predicting, for a future time point, based on the input data, for the first selected region a first amount of aflatoxin contamination for a first plurality of batches of crops using a predicting model, wherein the predicting model includes parameters that are optimized based on a comparison of a historical measured data set and a historical predicted data set. Additionally, the method includes predicting, the future time point, based on the input data, for the second selected region a second amount of aflatoxin contamination for a second plurality of batches of crops using the predicting model. Further, the method includes selecting one of the first or the second selected region to source maize batches for which the first amount of aflatoxin contamination or the second amount of aflatoxin contamination is lowest.

In certain non-limiting embodiments, the disclosure describes a method executed by one or more computing system. The method includes obtaining input data. The input data includes a first set of future meteorological data associated with a first selected region, a first set of farm-related data determining a first set of mitigating actions that can be performed at the first selected region, a second set of future meteorological data associated with a second selected region, and a second set of farm-related data determining a second set of mitigating actions that can be performed at the second selected region. Further, the method includes determining, at a future time point, based on the input data and a predicted first aflatoxin contamination for a first plurality of batches of crops, a first mitigating action from the first set of mitigating actions that reduces aflatoxin contamination at the first selected region. Additionally, the method includes determining, at the future time point, based on the input data and a predicted second aflatoxin contamination for a second plurality of batches of crops, a second mitigating action from the second set of mitigating actions that reduces aflatoxin contamination at the second selected region. Further, the method includes selecting either the first or the second mitigating action, resulting in a lowest level of aflatoxin contamination, to be performed at the corresponding first or second selected region, and sourcing from a selected region at which either the first or the second mitigating action is performed, which can be either the first or the second selected region.

In certain non-limiting embodiments, the disclosure describes a method executed by one or more computing system. The method includes obtaining meteorological data in time series associated with a selected region, and predicting an amount of A. flavus and aflatoxin contamination in the time series for a plurality of batches of crops using an integrated mechanistic model based on the meteorological data. The integrated mechanistic model includes estimated parameters and reference parameters, wherein the estimated parameters being optimized based on a comparison of a historical measured data set and a historical predicted data set. Further, the method includes identifying one or more of the plurality of batches of crops having a high risk of aflatoxin contamination, and evaluating the one or more batches of crops having a high risk of aflatoxin contamination for a presence of an additional pathogen.

In certain non-limiting embodiments, the additional pathogen includes Ustilago maydis, Puccinia sorghi, or a combination thereof.

In certain non-limiting embodiments, one or more computer-readable non-transitory storage media embodying software is operable when executed to obtain meteorological data in time series associated with a selected region, and to predict an amount of A. flavus and aflatoxin contamination in the time series for a plurality of batches of crops using an integrated mechanistic model based on the meteorological data, wherein the integrated mechanistic model comprises estimated parameters and reference parameters, wherein the estimated parameters being optimized based on a comparison of a historical measured data set and a historical predicted data set. The computer-readable non-transitory storage media embodying software is further operable when executed to identify one or more of the plurality of batches of crops having a high risk of aflatoxin contamination, and to evaluate the one or more batches of crops having a high risk of aflatoxin contamination for a presence of an additional pathogen.

In certain non-limiting embodiments, a system can comprise one or more processors and a non-transitory memory coupled to the processors comprising instructions executable by the processors. The processors are operable when executing the instructions to obtain meteorological data in time series associated with a selected region, and to predict an amount of A. flavus and aflatoxin contamination in the time series for a plurality of batches of crops using an integrated mechanistic model based on the meteorological data, wherein the integrated mechanistic model comprises estimated parameters and reference parameters, wherein the estimated parameters being optimized based on a comparison of a historical measured data set and a historical predicted data set. The processors are further operable when executing the instructions to identify one or more of the plurality of batches of crops having a high risk of aflatoxin contamination, and to evaluate the one or more batches of crops having a high risk of aflatoxin contamination for a presence of an additional pathogen.

It is to be understood that both the foregoing general description and the following detailed description are exemplary and are intended to provide further explanation of the disclosed subject matter claimed.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A depicts example monthly trends in maize rejection for different years.

FIG. 1B displays example monthly aflatoxin concentrations for several years.

FIG. 1C provides a summary of operations, including pre- and post-harvest, sourcing, and sampling procedures.

FIG. 1D is a bar graph indicating the relative proportion of maize batches sourced from different regions.

FIG. 2A is an example system for predicting aflatoxin contamination, according to an embodiment.

FIG. 2B is another example system for predicting aflatoxin contamination, according to an embodiment.

FIG. 2C is an example diagram describing the selection of mitigating actions to reduce aflatoxin contamination, according to an embodiment.

FIG. 3A is an example method for evaluating decisions related to processing and sourcing batches of crops in selected regions based on predicted levels of aflatoxin contamination, according to an embodiment.

FIG. 3B is an example method for evaluating decisions concerning the implementation of one or more mitigating actions to reduce aflatoxin contamination levels, according to an embodiment.

FIG. 4 provides an illustrative structure and operation of an integrated mechanistic model, according to an embodiment.

FIG. 5 offers an example visualization of the 5-parameter posterior distribution, obtained from the approximate Bayesian computation fitting of the integrated mechanistic model to historical data, according to an embodiment.

FIGS. 6A-6B display example time series for the integrated mechanistic model output (optimized parameter selection) and the data, with a monthly breakdown for both data and model predictions, according to an embodiment.

FIG. 7 presents maize rejection rates aggregated on a quarterly interval, comparing the model with historical data, according to an embodiment.

FIG. 8 depicts monthly rejection rates in a scatterplot format, according to an embodiment.

FIGS. 9A-9F illustrate aflatoxin boxplots, comparing monthly distributions of historical aflatoxin observations at the factory gate and model-predicted monthly aflatoxin distributions for the years 2012-2017, according to an embodiment.

FIG. 10 shows a model median confidence interval plot compared with historical data, according to an embodiment.

FIG. 11 features confidence intervals of model-predicted rejection rates generated from an ensemble of 100 independent model realizations, sampling from the posterior parameter distribution and comparing them with historical data, according to an embodiment.

FIGS. 12A-12C provide example maps depicting the average relative A. flavus growth rate and relative aflatoxin production rate in three sourcing regions.

FIGS. 13A and 13B show box plots illustrating averaged yearly growth rates for A. flavus within the Nizamabad region, for Kharif (FIG. 13A) and Rabi (FIG. 13B) harvests.

FIGS. 14A and 14B show illustrative predicted growth plots for A. flavus and aflatoxin production for three selected batches of maize in each of three sourcing regions, according to an embodiment.

FIG. 15 presents humidity, temperature, and A. flavus growth maps at selected regions.

FIG. 16 provides aflatoxin concentration plots based on historical data.

FIG. 17A shows time profiles of A. flavus growth in stored batches of crops.

FIG. 17B shows time profiles of aflatoxin concentration in stored batches of crops.

FIG. 18 illustrates a model prediction analysis of aflatoxin at the time of harvest, according to an embodiment.

FIG. 19A shows model predictions illustrating the effect of filtering on the reduction of aflatoxin concentration, according to an embodiment.

FIG. 19B shows model predictions illustrating the effect of temperature reduction on the reduction of aflatoxin concentration, according to an embodiment.

FIG. 20A illustrates model predictions depicting the effect of optimized sourcing of maize batches on the reduction of aflatoxin concentration, according to an embodiment.

FIG. 20B displays a scatter plot illustrating the effect of optimized sourcing of maize batches on the reduction of aflatoxin concentration, according to an embodiment.

FIG. 21 displays example hourly thermal unit accumulation in growing degree days (GDD).

FIG. 22 displays an example computing system for executing any of the methods described herein, as per various embodiments.

### DESCRIPTION OF EXAMPLE EMBODIMENTS

The present disclosure will now be described more fully hereinafter with reference to the accompanying drawings, which form a part hereof, and which show, by way of illustration, certain example embodiments. Subject matter can, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter can be embodied as methods, devices, components, and/or systems. Accordingly, embodiments can, for example, take the form of hardware, software, firmware or any combination thereof (other than software per se). The following detailed description is, therefore, not intended to be taken in a limiting sense.

### Definitions

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that can depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

### A. flavus Growth and Aflatoxin Contamination

The present disclosure provides systems, methods, and/or devices that can monitor, analyze and/or predict aflatoxin risk to maize. The presently disclosed subject matter addresses a practical problem concerning high levels of rejection of shipments of maize because of aflatoxin levels above the critical limit (e.g., 12 or 10 ppb). For example, a high-volume maize processing plant in Hyderabad in India was routinely rejecting 20% of monthly shipments rising to 40-55% in some years. The high rejection rate underlines the need for a predictive integrated mechanistic model to analyze and predict risk of contamination.

It is widely recognized that A. flavus growth and aflatoxin contamination can continue throughout prolonged periods of grain storage after harvest. Most quantitative and modelling approaches to assessing the risks of aflatoxin have focused on modelling within field pre-harvest dynamics. An initial audit indicated a strong locational effect of where maize was grown and then stored, often at multiple sites in the supply chain, on subsequent levels of aflatoxin contamination. The dual cropping seasons for Kharif and Rabi crops also affect the duration and impacts of storage on subsequent contamination. Accordingly, some of the embodiments disclosed herein describe a model that integrates pre-harvest and post-harvest dynamics of A. flavus and production of aflatoxin to assess risk of contamination. Some of the embodiments disclosed herein disclose a meteorologically-driven, spatially-structured post-harvest integrated mechanistic model that is coupled with a meteorologically-driven spatially-structured pre-harvest integrated mechanistic model that allows tracking A. flavus growth and aflatoxin contamination for batches of maize through the supply chain. The disclosed integrated mechanistic model can be applied to various agricultural scenarios including dual cropping seasons and multiple sourcing regions for maize crops within a supply chain. Further, the integrated mechanistic model can be validated using data available from the maize processing plant in Hyderabad.

Using the integrated mechanistic model to predict A. flavus dynamics and aflatoxin production offers several technical advantages in identifying strategies to minimize contamination in maize batches and determining the best sources for maize procurement. Some technical advantages may include modeling where and when the crop is grown and harvested with a view to optimizing sourcing, and to produce a framework that is adaptable for different countries and meteorological environments. Highly spatially resolved pre-harvest and post-harvest data are scarce especially in low-income and middle-income countries. Certain embodiments disclosed herein may use reliable data for aflatoxin contamination on shipments reaching factory gate for processing to parameterize and validate the integrated mechanistic model. Certain embodiments disclosed herein may assess the performance of the integrated mechanistic model in simulating and predicting timeseries for A. flavus contamination and aflatoxin levels in batches from different sourcing regions during the cropping and storage phases of the supply chain. Following parameterization and validation, certain embodiments disclosed herein may illustrate the use of the integrated mechanistic model as a tool for nowcasting for decision support and for scenario analysis to assess the effectiveness of different intervention and sourcing strategies in minimizing risk of aflatoxin contamination.

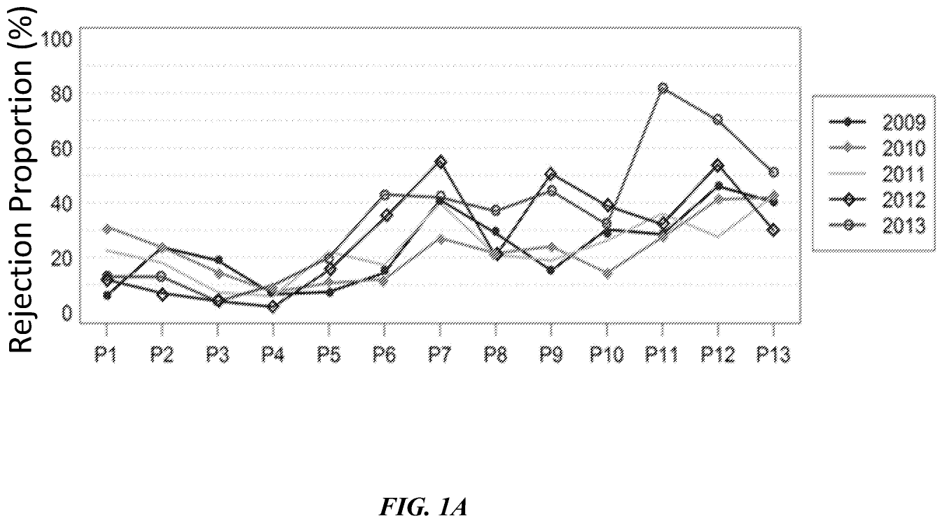

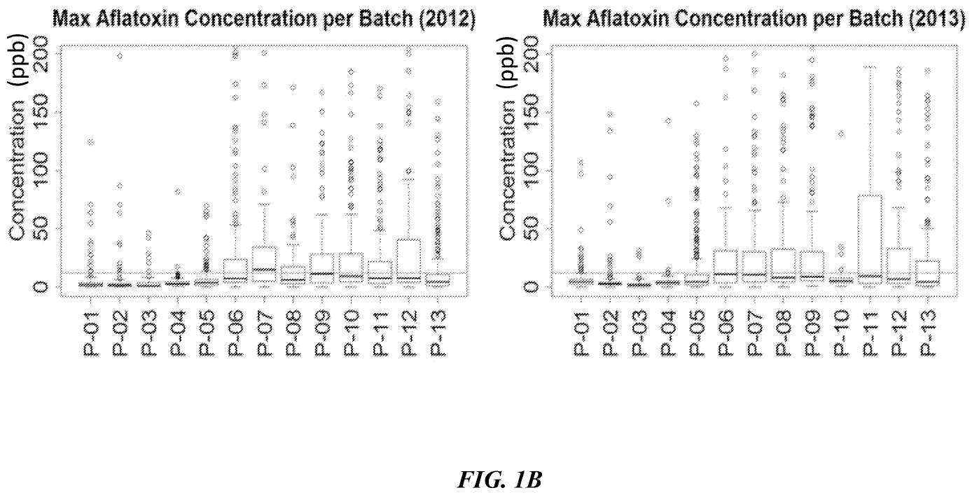

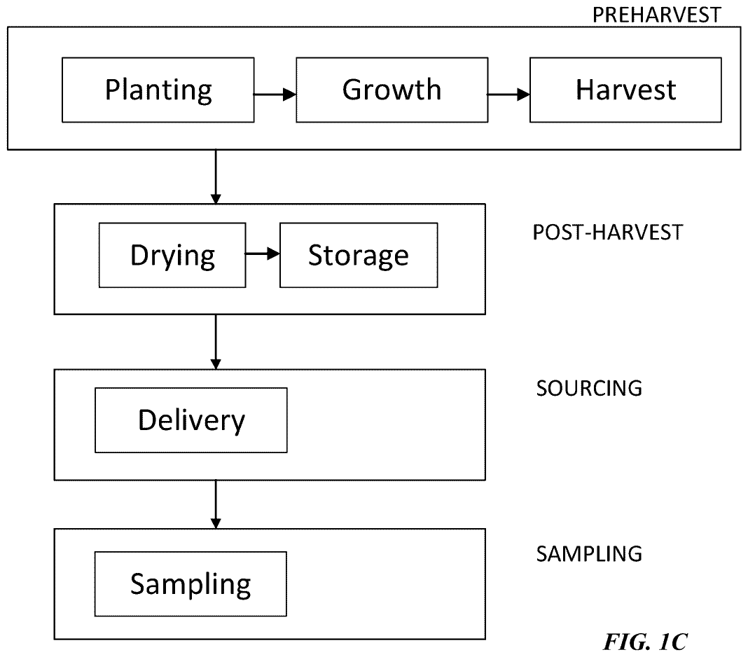

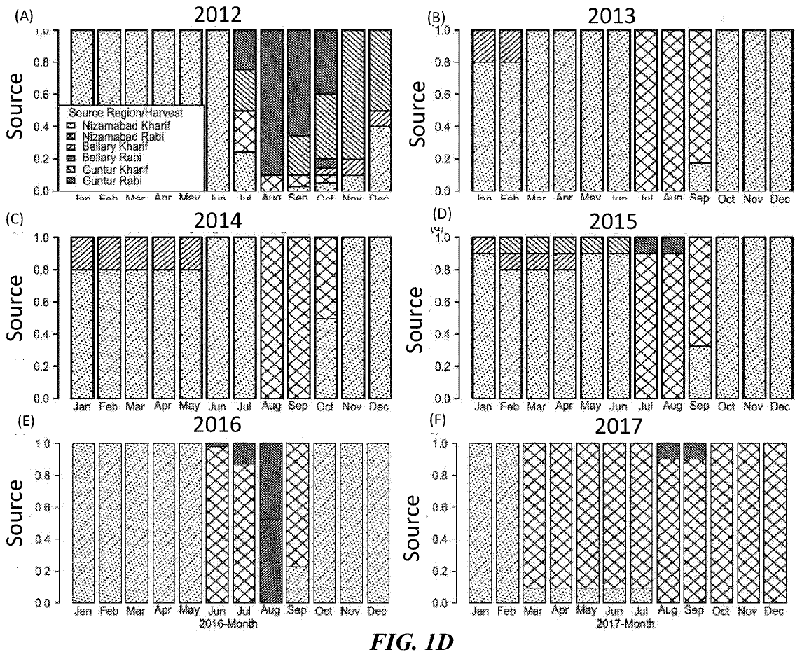

Often, when it is found that a specific maize batch contains aflatoxin levels surpassing a defined threshold, such as exceeding 12 parts per billion (ppb), it may become necessary to discard the entire batch. This can result in significant inefficiencies in maize farming operations. FIG. 1A illustrates monthly rejection trends for maize batches received in the southern coastal region of India, specifically in the state of Andhra Pradesh. As depicted in FIG. 1A, there is a notable variability throughout several years, spanning from 2009 to 2013. The rejection rates can fluctuate from a few percent to as high as 80% across different months and years. Furthermore, rejection rates are notably elevated in the later months of the year, particularly during a period denoted as P11-P13, corresponding to the winter months. Note here period P01 to P02 corresponds to month of January, period P02 to P03 corresponds to month of February, and so on. FIG. 1B shows monthly aflatoxin distributions for years 2012-2013. Note that there is a significant concentration of aflatoxin in the later months of the year, corresponding to high rejection rates as shown in FIG. 1A.

FIG. 1C shows an example pre- and post-harvest operations as well as sourcing (e.g., delivery) and sampling operations. A pre-harvest period corresponds to a period of planting, growth, and harvesting the maize kernels, while post-harvest includes drying the maize kernels and storing the maize kernels. Sourcing includes delivering the maize batches, which may include transporting, as well as locally storing the maize batches. Sampling includes selecting some of the maize batches from the delivered maize batches to evaluate for the presence of aflatoxin.

FIG. 1D shows historical data indicating sourcing of maize batches from different regions. FIG. 1D shows that most material was sourced for the factory from the Nizamabad area. The larger Kharif crop is also more commonly used for sourcing, with the Rabi crop typically being sourced in the mid-late year periods. When Nizamabad is not the sole sourcing region, material may be obtained from Bellary, typically in the first five months of the year as in 2013-2015, or Guntur towards the middle of the year. Sourcing in 2012 was more diverse than in later years, reportedly the switch to more focused sourcing profiles was driven by high observed contamination levels that year.

### System and Methods Overview

The issue of aflatoxin contamination results in the rejection of a significant number of maize batches, with rejections accounting for over 30% of maize batches for an extended period each year, occasionally reaching rejection rates as high as 75%. These high rejection rates are not only wasteful but also pose a risk of material shortage for processing, leading to substantial economic costs and potential damage to the reputation of producers. Moreover, failure to detect infected batches exceeding the prescribed threshold of 12 ppb of aflatoxin presents a significant health risk to consumers of maize, including farm animals, pets, and humans.

Despite the health risks associated with seasonal spikes in aflatoxin contamination, the problem remains largely underreported within the industry and is often underappreciated by wider communities of farmers, traders, and other maize processors. It is worth noting that improvements to the maize system could have broader applications in reducing the risk of aflatoxin contamination in other crops.

Practical considerations for acquiring top-quality maize batches include optimizing the supply chain and adjusting it in response to changing weather conditions, Supply chain optimization involves decisions aimed at minimizing the risk of unacceptable levels of aflatoxin contamination at the factory gate. Additionally, it entails decisions about sourcing maize batches, including choices related to regions, markets, traders, suppliers, and farms. Furthermore, supply chain optimization extends to decisions about where and how to store grain, particularly for longer durations, and how to optimize the sampling procedures for maize batches to assess aflatoxin contamination levels. Adjusting of the supply chain addresses strategies to respond to changing weather conditions and adapt sourcing and storage procedures accordingly.

To facilitate these decisions regarding supply chain optimization and adaptation, it is important to develop systems and methods for forecasting aflatoxin contamination in maize batches as well as tracing contaminated maize batches.

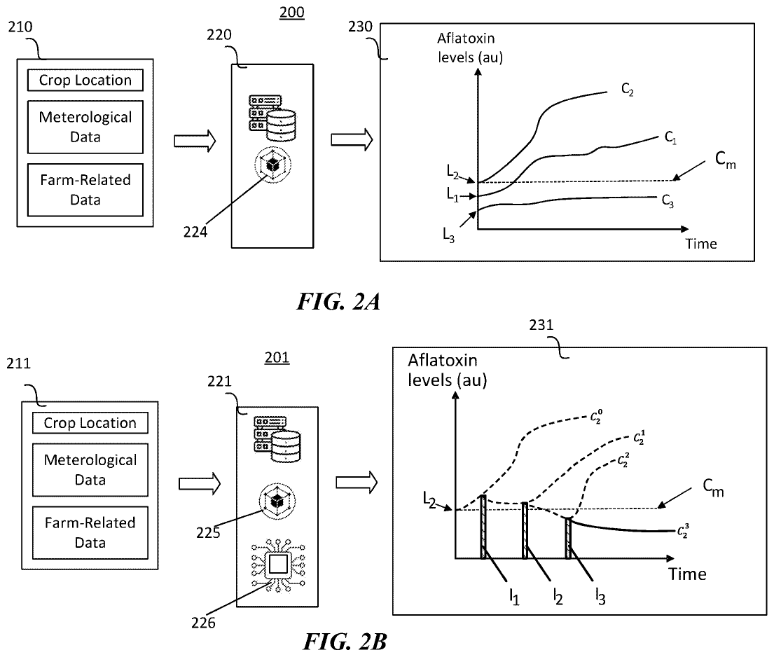

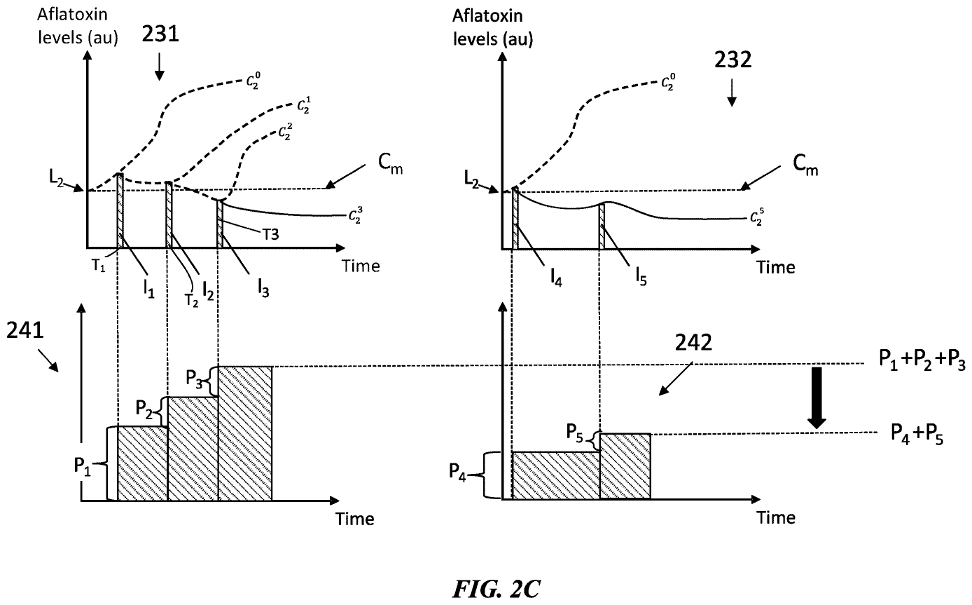

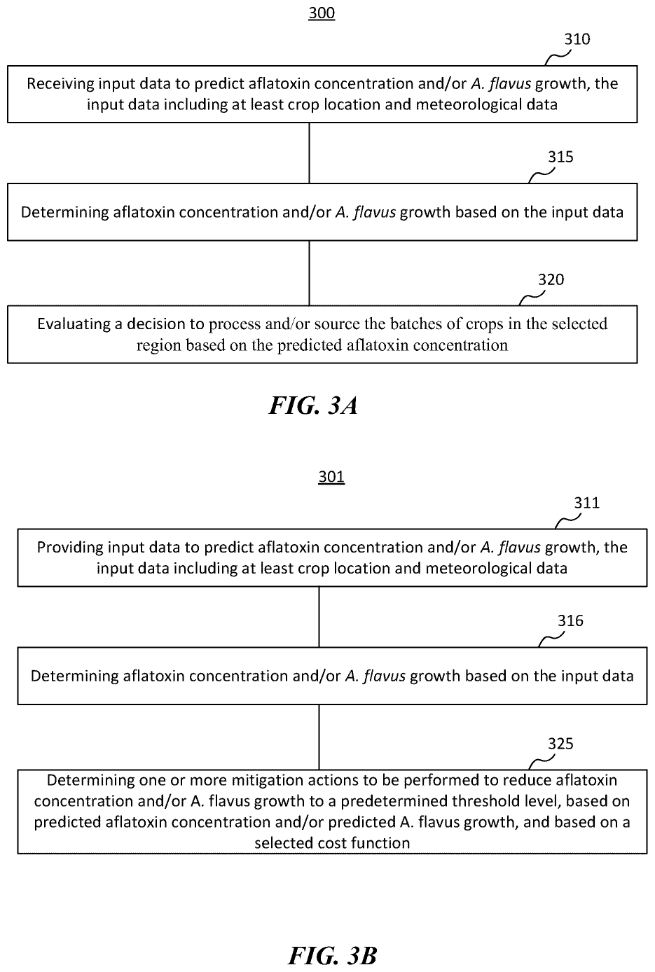

An illustrative embodiment of a system 200 for predicting aflatoxin contamination in maize batches is depicted in FIG. 2A. System 200 is designed to process input data 210 using a computing system 220 and generate aflatoxin contamination predictions 230 (and/or A. flavus dynamics) for various time intervals.

Input data 210 may include various input data that can be used by computing system 220 to generate aflatoxin contamination predictions 230. For example, input data 210 may include crop location information related to the geographical aspects of the crop, meteorological data associated with the crop location, and farm-related data. The crop location includes details about the specific location of the crop, such as the geographical coordinates of a particular farm within a specific country, the positions of the fields where maize is cultivated, the locations of the storage facilities, the transportation routes used for transporting maize batches, and similar location-based data.

Additionally, input data 210 may include meteorological data. This meteorological data includes various environmental factors that can influence the growth of A. flavus. Such meteorological data may include temperature data, relative humidity, dew point, the presence of water at the maize growth and storage locations, precipitation levels, sunlight exposure, wind conditions, and the occurrence of extreme weather events, such as hail or tornadoes. In different embodiments, the meteorological data can include historical, current, and forthcoming meteorological information. Additionally, future meteorological data may, in certain instances, be accompanied by error bars to signify the degree of uncertainty associated with this forthcoming data.

Furthermore, input data 210 may incorporate specific farm-related data, i.e., data related to the maize farms. Such farm-related data may include a range of parameters that affect the harvesting and storage of maize on a particular farm. These parameters might include the efficiency of the maize collection process (e.g., the thoroughness of cleaning maize plants, kernels, silks, etc.), the sanitary conditions of the maize storage environment, the application of processes like filtering and drying at the farm, and related factors. In some instances, the farm-related data may contain details regarding ventilation systems and pest control measures. Furthermore, the farm-related data could include information on the frequency of monitoring maize batches for contamination, infection, or spoilage, as well as whether crop rotation is practiced to minimize cross-contamination between plants. Additionally, the farm-related data may include details about the storage methods employed, such as the use of elevated above-ground bins or bags.

As depicted in FIG. 2A, input data 210 is provided to computing system 220, and a predictive model 224 is configured to process input data 210 and generate aflatoxin contamination predictions 230. In various embodiments, predictive model 224 is implemented as a computer-based model that processes input data 210. It utilizes information related to the location as well as historical, current, and future meteorological data to determine aflatoxin contamination predictions 230. Predictive model 224 can take the form of various suitable models, including integrated mechanistic models, statistical-based models, crop growth and disease models, or any other model capable of producing aflatoxin contamination predictions 230. By way of example and not to restrict the description, the integrated mechanistic model based on spore formation rates, germination rates, and A. flavus growth can be used. However, It is important to note that any other appropriate models trained on historical data for determining aflatoxin contamination predictions 230 may be employed. These could include machine learning models based on various machine learning techniques, such as deep neural networks (including convolutional neural networks, recurrent neural networks, generative adversarial neural networks (GANs), infoGANs, decision trees, classification trees, and similar approaches.

Aflatoxin contamination predictions 230 can be represented by any suitable data and can take various forms and be presented in diverse formats, offering insights into aflatoxin contamination for future periods, including upcoming days, weeks, months, and beyond. In an illustrative embodiment, these predictions are depicted through concentration curves, denoted as C₁, C₂, and C₃, as shown in FIG. 2A. These concentration curves serve to represent the levels of aflatoxin within batches of maize that have been harvested and stored at one or more farms. In one example, concentration curve C₁ may correspond to maize batches collected at a first location L₁ (e.g., at a first farm), concentration curve C₂ may correspond to maize batches collected at a second location L₂ (e.g., at a second farm) and concentration curve C₃ may correspond to maize batches collected at a third location L₃ (e.g., at a third farm).

As seen from FIG. 2A, maize batches gathered from the first and second locations, L₁ and L₂, exhibit notable increases in aflatoxin concentration over time, reaching levels that surpass a predefined safety threshold, denoted as Cₘ. However, the maize batches collected from the third location, L₃, appear to maintain relatively lower concentrations of aflatoxin, potentially falling below the critical Cₘ threshold. This observation implies that selecting maize batches from a farm situated at L₃ may result in aflatoxin levels that remain within safe limits, providing distinct advantages in the procurement of high-quality maize crops. Thus, system 200 provides a functionality of determining from which farms procurement of maize crops is advantageous.

It is important to recognize that the farm's geographical location is just one of several factors influencing the quality of maize batches. Depending on the time of the year, it might be beneficial to source maize from a different location, such as L₃, whereas at another time, sourcing from L₁ could be advantageous. Additionally, aside from the farm's geographical location, it may be important to consider various storage facilities for maize batches, transportation routes for these batches, and similar factors.

Furthermore, It is worth noting that if the maize batches from L₁ are significantly discounted compared to those from L₃, it could be advantageous to procure maize from L₁ and then remove some of the contaminated maize plants after obtaining suboptimal-quality maize batches.

As can be seen from the discussion above, obtaining high-quality maize batches is a problem in optimization, and the present disclosure further presents system and methods for optimizing the procurement of high-quality maize batches. It is worth noting that, while the contamination of the maize is discussed, the systems and methods described herein can be applied to predict contamination, infection, and spoilage in various other crops. This extends to crops such as peanuts, cottonseed, tree nuts, oil-producing seeds (e.g., sunflower), spices, grains, legumes, and dried fruit, among others. Furthermore, the discussed systems and methods can be readily adapted to anticipate contamination by a range of other fungi, including Ustilago maydis, Puccinia sorghi, various species of Fusarium fungi, Cladosporium species, and the like.

FIG. 2B, shows a system 201, which is structurally and functionally similar to system 200. System 201 is designed to process input data 211 using a computing system 221 and generate aflatoxin contamination predictions 231 (and/or A. flavus dynamics) for various time intervals. In various embodiments, input data 211 may be the same as input data 210. The point of distinction between system 201 and system 200 lies in the inclusion of an optimization model 226 within computing system 221. Similar to computing system 220, computing system 221 includes predicting model 225 which may be functionally the same or similar to predicting model 224 of computing system 220. Optimization model 226, is designed to assess and recommend adjustments to various parameters pertaining to the harvesting and post-harvest processes, with the goal of mitigating aflatoxin contamination in maize batches. In some cases, optimization model 226 may be configured to determine the procurement location for maize batches. Further, in some cases, optimization model 226 may be configured to also recommend adjustments to various parameters pertaining to the pre-harvest processes. Additionally, in some implementations of system 201, optimization model 226 is configured to adjust parameters of predicting model 225 based on new data related to aflatoxin contamination obtained for different crop locations and different times.

FIG. 2B displays aflatoxin contamination predictions 231, which, much like aflatoxin contamination predictions 230, may depict potential changes in aflatoxin contamination over time. These aflatoxin contamination predictions are further depicted in FIG. 2C, exemplified by possible aflatoxin concentration curves

$${C}_{2}^{i}$$

for maize batches harvested at location L₂ (herein superscripts i for

$${C}_{2}^{i}$$

curves indicate different possible trajectories for a C₂ curve based on mitigating actions taken to affect the C₂ curve, as further described below). Please note that FIG. 2C presents possible concentration curves

$${C}_{2}^{i}$$

for illustrative purposes only, and it is recognized that any other concentration curves, such as

$${C}_{1}^{i} or {C}_{3}^{i} ,$$

can be subject to analysis.

FIG. 2C illustrates instances of interference actions, denoted as I₁, I₂, and I₃ (herein also referred to as mitigating actions), executed at times T₁, T₂, and T₃ to reduce the aflatoxin contamination in maize batches. These actions can involve a range of suitable measures aimed at reducing the levels of aflatoxin contamination or inhibiting aflatoxin production. For instance, though not an exhaustive list, mitigating actions may involve processes like maize cleaning, contaminant removal, silk extraction, maize cooling, drying procedures, crop rotation to distance maize from potential contamination sources, and similar strategies. In certain scenarios, mitigating actions may also involve the transportation of maize to an alternate location or the regulation of environmental factors at storage sites, such as temperature and relative humidity control.

In various cases, based on the meteorological data, farm-related data, and crop location data of input data 211, as shown in FIG. 2B, and based on a state of maize plants at a given time, optimization model 226, as shown in FIG. 2B, is configured to assess the effect of any given mitigation action on reduction of the aflatoxin contamination in maize batches. For example, as shown in FIG. 2C, the first mitigating action I₁ performed at time T₁ may lead to a possible concentration curve

$${C}_{2}^{1}$$

which is different from a possible concentration curve

$${C}_{2}^{0}$$

(e.g., the mitigation action I₁ reduces the concentration of aflatoxin at least for some period of time as exemplified by curve

$${C}_{2}^{1} ) .$$

Similarly, the second mitigation action I₂ performed at time T₂ leads to a possible concentration curve

$${C}_{2}^{2} ,$$

and the third mitigation action I₃ performed at the time T₃ leads to a possible concentration curve

$${C}_{2}^{3} .$$

Mitigating actions I₁-I₃ may have associated respective costs P₁-P₃ as shown by plot 241.

Optimization model 226 can be configured to either select one or more mitigating actions to be executed (or recommended for execution by a farmer, trader, maize batch supplier, and similar stakeholders) for the purpose of reducing aflatoxin contamination in maize batches. Alternatively, optimization model 226 may consider the mitigating actions undertaken by a farmer, trader, maize batch supplier, and the like, in order to project aflatoxin contamination levels in maize batches at future time points. In certain cases, the optimization model 226 may determine a set of mitigating actions that not only bring aflatoxin levels below the defined threshold value of Cₘ but also optimize the cost associated with implementing these mitigation measures.

For instance, in aflatoxin contamination predictions 232, potential changes in aflatoxin contamination over time are illustrated when mitigating actions I₄ and I₅ are employed at respective times T₄ and T₅. These mitigating actions may differ from the previously discussed I₁-I₃ actions, and times T₄ and T₅ may vary from T₁-T₃. As depicted in FIG. 2C, mitigating actions 14 and Is effectively reduce aflatoxin contamination, as indicated by curve

$${C}_{2}^{5} ,$$

while incurring their respective cost P₄ and P₅. In a practical implementation, if the total cost P₄+P₅, as shown by plot 242, is less than the sum of costs P₁+P₂+P₃, the optimization model 226 might opt to select mitigating actions I₄ and I₅ over mitigating actions I1-I3.

In general, the optimization model 226 can take into account a wide array of parameters when determining a set of mitigating actions aimed at reducing aflatoxin concentrations in maize batches for procurement. In some cases, when mitigating actions are not possible, the optimization model 226 may at least determine a location (e.g., location L₁, L₂, or L₃) from which to procure the maize batches. In general, optimization model 226 may include (or receive from a user of system 201) a defined cost function (e.g., cost of mitigating actions as described by cost P₁+P₂+P₃ or cost P₄+P₅), which, when being minimized, results in selection of one or more mitigating actions. It is important to note that the cost of mitigation actions is just one of several possible cost functions. Other cost functions may involve stipulating that aflatoxin contamination falls below a specific threshold level, considering a combination of mitigation action prices and the reduction in aflatoxin within maize batches, or any other appropriate cost function that represents particular mitigation requirements. In some cases, the cost function may also include a penalty when selecting maize batches from a first crop location (e.g., location L₁) comparing to selecting maize batches from a second crop location (e.g., location L₂). Additionally, or alternatively, the cost function can incorporate a reward for endorsing a specific farm location or agricultural region, whether it pertains to a farm, a trader, a supplier, or similar entities.

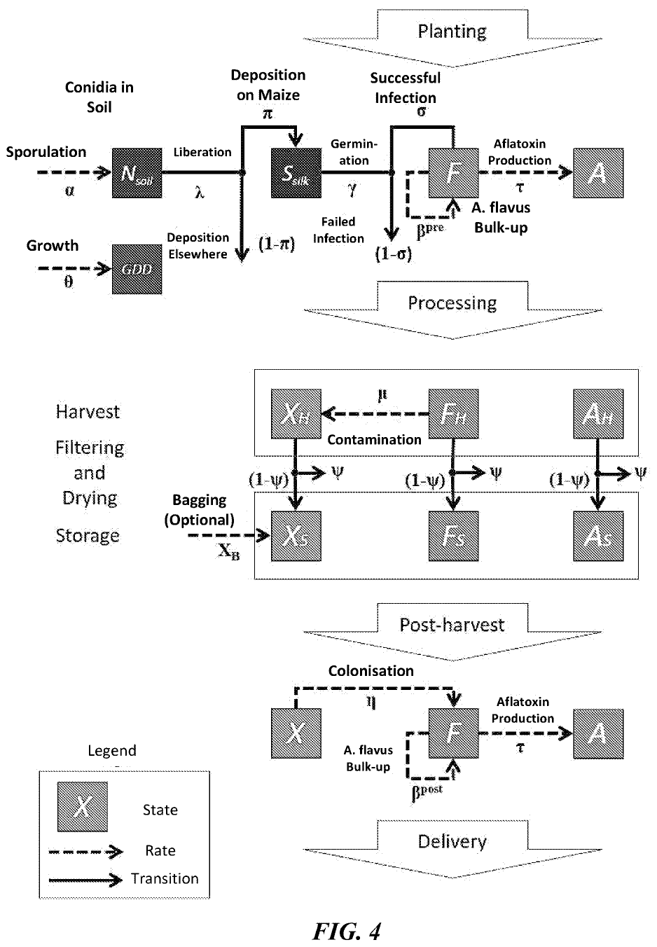

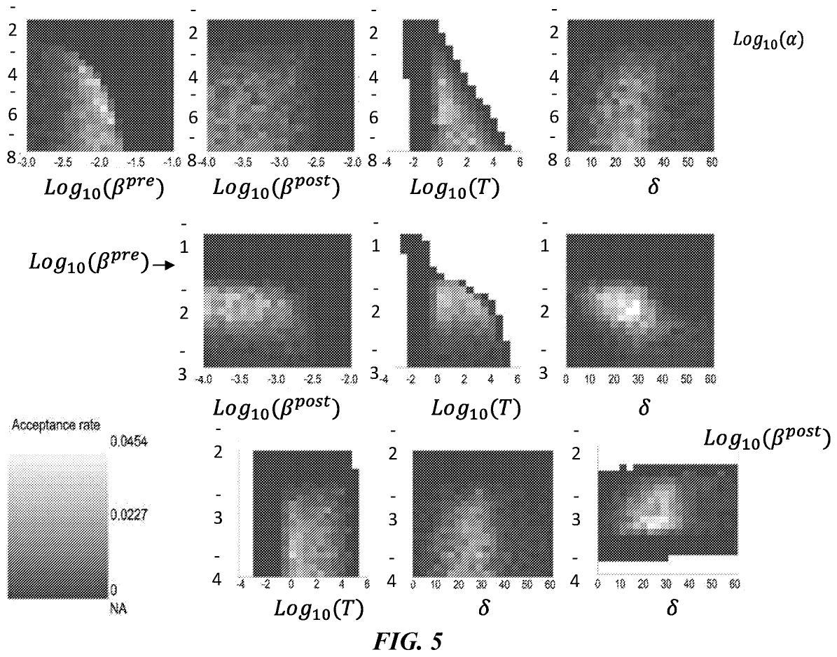

FIG. 3A provides an overview of a method 300, that can be executed by a system, similar to the one represented by system 200 or system 201, with the goal of improving the acquisition of high-quality maize batches through the reduction of aflatoxin contamination in those batches. Method 300 includes, at step 310, receiving input data to predict aflatoxin concentration and/or A. flavus growth, with the input data including at least crop location and meteorological data. In an example implementation, the input data may resemble or be identical to input data 210. In some cases, this data might also include farm-related data. Additionally, it can include details relevant to decisions concerning maize batch procurement and processing. For instance, this information may include costs associated with both procurement and processing of maize batches.

At step 315, method 300 includes determining aflatoxin concentration and/or A. flavus growth based on the provided input data. Such determination is performed by a computing system functionally similar to computing system 220 or computing system 221, as described in relation to FIG. 2A or 2B. The determination of aflatoxin concentration and/or A. flavus growth may be made for any suitable time period (e.g., for the next day, a few days, a week, a few weeks, a month, a few months, and the like). A prediction of an amount of A. flavus and aflatoxin contamination may be made in the time series for a plurality of batches of crops using an integrated mechanistic model based on the input data that includes the meteorological data. In various cases, the integrated mechanistic model may include estimated parameters and reference parameters, wherein the estimated parameters are optimized based on a comparison of a historical measured data set related to the amount of A. flavus and aflatoxin contamination and a historical predicted data set.

At step 320, method 300 includes evaluating a decision of processing the batches of crops in a selected region (e.g., at a crop location, at a particular storage location, and the like) or sourcing the batches of crops from the selected region based on the predicted amount of A. flavus and the predicted aflatoxin contamination. For example, the evaluation may include deciding not to process the maize batches at the selected location or source them from the selected location if the aflatoxin amount exceeds safe threshold levels (e.g., exceeding 12 ppb, 10 ppb, and the like).

FIG. 3B shows another method 301 which may be a variation of method 300.

Similar to method 300, method 301, can be executed by a system, similar to system 201, with the goal of enhancing the acquisition of maize batches through the reduction of aflatoxin contamination in those batches. Steps 311 and 316 of method 301 may be similar or the same as steps 310 and 315 of method 300. Further, method 301 includes, at step 325, determining one or more mitigating actions to be performed to reduce aflatoxin concentration and/or A. flavus growth, based on predicted aflatoxin concentration and/or predicted A. flavus growth, and based on a selected cost function. The determination of mitigating actions may be performed by an optimization model functionally similar or the same as optimization model 226, as shown in FIGS. 2A and 2B. The mitigating actions may be any suitable actions, such as filtering maize batches, drying maize batches, changing temperature or humidity at a location where the maize batches are stored, cleaning bins or bags in which maize batches are stored, and the like, as previously discussed, in relation to system 201. In addition, mitigation action may include a decision of procuring maize batches harvested from a particular location, stored at a particular location, transported by a particular transportation agent, or traded at a particular market. Furthermore, the optimization model is configured to select such mitigating actions that minimize the selected cost function. For example, the selected cost function may be determined as the amount of aflatoxin concentration and/or A. flavus growth at a particular time (e.g., in a month, when maize batches are sourced), or at several time points (e.g., throughout the storage of maize batches). The cost function may include the cost of mitigating actions selected for reducing aflatoxin concentration and/or A. flavus growth, the cost of sourcing from a particular location, a reward for supporting a particular farm or region, or any other consideration that can influence the decision of selecting one or more mitigating actions for reducing aflatoxin concentration and/or A. flavus growth.

In various scenarios, steps 320 and 325 in methods 300 and 301 are executed by computing systems 200 or 201, utilizing appropriate computing resources such as cloud computing, edge computing, or any other computing infrastructure configured for the analysis of aflatoxin concentration and A. flavus growth prediction, as well as the determination of mitigating actions. Specific sub-steps within step 325 may involve numerical calculations including, for example, the selection of mitigating actions that minimize the cost function using algorithms like gradient descent or similar methods (e.g., conjugate gradient descent, and the like).

### Detailed Model Description

In various embodiments, the models for predicting pre- and post-harvest growth of A. flavus and aflatoxin production can be parameterized and validated by comparing model predictions with time series data on daily aflatoxin measurements in maize shipments taking account of meteorological conditions experienced by the maize throughout the supply chain. Some of the model parameters can be taken from pre-existing studies. Certain parameters, for which there were no known plausible values, can be estimated from the time series data for aflatoxin measurement at the processing plant, using approximate Bayesian computation techniques.

In particular embodiments, parameters for these models can be determined based on meteorological data. Meteorological data for temperature, humidity and rainfall in the target regions were obtained for the years corresponding to the aflatoxin time series data use for model training for years 2012-2015 and validation for years 2016-2017. The meteorological data are provided with 3-hourly temporal and 10 km resolution. The temporal data were linearly interpolated to 1-hourly temporal resolution.

Data for aflatoxin concentration for daily shipments from a maize processing facility in Hyderabad, India were used for parameterization and validation. Batches of maize are taken from storage in markets and sent as shipments to the factory on a daily basis throughout the year. The maize is shipped in 50-60 kg jute bags on trucks holding a mean of 5 tons of maize, with an average of seven shipments delivered per day. The maize is obtained from different commercial suppliers who source their maize from distinct sourcing regions, Bellary Guntur and Nizamabad, within Karnataka, Andhra Pradesh and Telangana States, respectively, at different times of the year. Upon receipt of a shipment of maize at the processing facility, factory staff test samples of each shipment for aflatoxin content, recording aflatoxin level (in ppb) for each shipment. Aflatoxin time series data for 2012-2015 recorded at the processing factory were used to fit and parameterize the model; aflatoxin time series data for 2016-2017 were used for additional validation.

Maize is grown in India during two distinct (Rabi and Kharif) growing seasons, generally on small-holder farms. Rabi crops are planted between October and December and harvested between March and May, whereas Kharif crops are planted between June and August and harvested between November and January. After harvesting and de-cobbing, maize kernels may be subject to processing such as drying or filtering. After a short period of on-farm storage the maize kernels are taken to local markets (Mandis) within each region in 50-60 kg jute bags. Here the individual bags of maize are bought and sold in batches, before being either sent to a final destination, such as a maize processing factory, or being stored locally in warehouses (some of which are climate controlled). At each stage in the life history of a single batch of maize (whilst on the plant in the field, or within a bag in transit and storage), local environmental conditions, notably temperature, humidity and rainfall affect the biological processes that govern A. flavus growth rates and aflatoxin production rates.

In particular embodiments, a computing system can use a discrete-time compartment model to track A. flavus and aflatoxin levels on maize within the pre-harvest, processing and post-harvest components of the integrated model. The pre-harvest model is configured to track the colonization and growth of A. flavus and aflatoxin accumulation in Kharif and Rabi maize crops on a large number of farms (e.g., one thousand farms) in the three representative sourcing regions for the Hyderabad factory: Bellary, Guntur and Nizamabad, located respectively in Karnataka, Andhra Pradesh and Telangana states. The post-harvest model can then track the growth of A. flavus and aflatoxin accumulation on the harvested grain on farm and in store allowing for the influence of cultural practices to reduce infection as well as movement and storage of batches of maize in the sourcing regions before arrival at the factory-gate in Hyderabad. Meteorological data can be used to drive growth and susceptibility of maize, the growth of A. flavus and accumulation of aflatoxin on farm and in store.

A rectangular region from longitude 76.67° to 81.42° and latitude 14.20° to 19.70° was chosen to cover the relevant sourcing areas and processing sites. This region was divided into a grid of 3,762 “cells” (57×66), each of which was 1/12× 1/12 decimal degree wide and high, approximating to 10 km×10 km in size.

Temperature, rainfall and relative humidity data were extracted for the target regions region in each cell at 3-hourly temporal resolution from January 2011 to September 2017. The data were linearly temporally interpolated to 1-hourly resolution resulting in ˜180,000 spatially explicit maps of the ambient environmental conditions from which hourly maps were constructed as driving variables for sporulation, liberation, germination rates of A. flavus, and for relative growth and relative aflatoxin production rates. Mapping the three supply regions onto the spatial grid gives 383 meteorologically unique cells where maize could be grown: Nizamabad (223), Bellary (95) and Guntur (65). Each season, 1,000 fields with a random location and sowing date in each of the three regions are seeded. Using the models described below a computing system can simulate maize growth and A. flavus dynamics in individual fields to generate a distribution of pre-harvest A. flavus levels for each source region. In the absence of detailed information on exact sowing and harvesting dates for the Rabi and Kharif crops the embodiments disclosed herein assumed a uniform distribution of sowing dates: 16^{th} October to 30^{th} November for Rabi and 1^{st} June and the 31^{st} of July for Kharif. Initially, crops are introduced as free of A. flavus and aflatoxins. Maize crops are harvested after 1,500 growing degree days, at which point the batch moves to the harvest processing stage of the model.

### Pre-Harvest Model

One of the approaches used for the pre-harvest model component revolves around an explicit epidemiological model for the level of A. flavus infection within a field of crops. The maize infection process may be determined by four distinct biological processes, each of which is affected by different environmental conditions including sporulation, spore liberation and deposition, germination and successful initial infection, and growth.

The sporulation refers to spore production. It is assumed that colonies of Aspergillus flavus hyphae are endemic within the maize growing regions of Andhra Pradesh/Telangana and that these hyphal colonies within the soil produce fruiting bodies (conidiophores) during the maize growing seasons. These fruiting bodies produce spores only under specific environmental conditions (high humidity and specific temperature ranges). The rate of spore production is modelled and the number of spores available within the soil is tracked over time.

The spore liberation and deposition refers of liberation of the spores and deposition of the spores for successful growth of A. flavus. In order for A. flavus spores to have the possibility of initiating infections in the maize crops two things have to occur: (a) the spores have to be liberated from the conidiophores, which can only occur if the conidiophores do not have a layer of water/dew on them (as this traps the spores), and (b) the spores must land on the silks of the maize crop, which can only happen if the crops are at the correct maturity level. The rate of liberation can be modelled using environmental thresholds for leaf wetness/dew formation and the possibility of spores landing on the silks is determined by the maturity stage of the maize, which in turn is determined by the accumulated number of growing degree days the crops have experienced. Growing degree days are calculated from the local temperature data in the maize growth section of the pre-harvest model. The rate of liberation is modelled and the proportion of liberated spores that successfully land on maize silks is tracked over time.

The germination and successful initial infection describe how spores that have landed on the maize silks can successfully infect the plant. For the infection to take place, two conditions must be met: (a) the spores need to meet the environmental conditions required to germinate (high humidity and specific temperature ranges), and (b) the maize plants must be at a susceptible stage in their development (susceptibility increases and then decreases as the plants mature). These conditions are affected by the number of growing degree days that the crops have experienced. The rate of germination is modelled and the number of spores that successfully initiate infections is recorded over time.

The growth process discussed in this disclosure pertains to the growth of A. flavus. Once a maize plant becomes infected, the A. flavus population can proliferate over time if local environmental conditions are suitable. A. flavus growth is dependent on maintaining high levels of water activity and specific temperature ranges. The growth rate is quantified, and the quantity of A. flavus within the crop is monitored up until the point of harvest.

In particular embodiments, the pre-harvest epidemiological model is described by discrete time equations for four state variables (with dimensions of unit area of crop).

$$A . flavus spores in soil {N}_{t + 1} = {N}_{t} + {α}_{t} - {λ}_{t} {N}_{t} ,$$

$$A . flavus spores on silks {S}_{t + 1} = {S}_{t} + {π}_{t} {λ}_{t} {N}_{t} - {γ}_{t} {S}_{t} ,$$

$$A . flavus infections on maize {F}_{t + 1} = {β}_{t}^{p r e} {F}_{t} ( 1 - {F}_{t} ) + {σ}_{t} {γ}_{t} {S}_{t} ,$$

$$Aflatoxin on maize {A}_{t + 1} = {A}_{t} + {τ}_{t} {F}_{t} .$$

The principal parameters are listed in Table 1 and Table 2 including parameters λ₀, π₀, γ₀ and σ₀, which define respective parameters λₜ, πₜ, γₜ, and σₜ. Here, subscript τ indicates that the parameters are evaluated at time t, and the parameters are further defined in Table 1 and Table 2. Note that the rate constants λ₀, π₀, γ₀ and σ₀ can be set to 1.0 without loss of generality as these values are absorbed into the fitted constant do, while parameters μ, ψ and X_{B} were set to zero during parameter estimation.

The pre-harvest model can use results from some conventional work to describe meteorologically driven sporulation and infection processes (e.g., hourly sporulation rate as a function of local air temperature and relative humidity). In particular embodiments, the computing system can model maize growth using an accumulated thermal unit (growing degree day, GDD) process, by calculating GDD contributions from hourly temperature data. Internal water activity, awᵢ, can be determined by the growth stage of the plant or crop (GDD). This in turn can allow for modeling maize susceptibility. These sources of information allow for calculating infection process rates, A. flavus growth rates and susceptibility rates at an hourly resolution using the local environmental data for the target regions.

TABLE 1
Summary of key parameters used in the integrated model for pre-harvest,
processing and post-harvest dynamics of A. flavus growth
and aflatoxin production.

| | | |
|---|---|---|
| Variable/Parameters | Description | Rate constant |

Pre-harvest model: A. flavus growth and aflatoxin production

| | | |
|---|---|---|
| α | Sporulation rate | α₀ (Estimated) = 1.00 × |
| | | 10⁻⁵ |
| λ | Liberation rate | λ₀ = 1.0 |
| π | Deposition | π₀ = 1.0 |
| | Proportion | |
| γ | Germination rate | γ₀ = 1.0 |
| σ | Susceptibility | σ₀ = 1.0 |
| β^{pre} | Pre-harvest A. flavus growth rate | ${β}_{0}^{p r e} ( Estimated ) = 6.31$ × 10⁻³ |
| τ | Aflatoxin | τ₀ (Estimated) = 5.06 |
| | production rate | |

Post-harvest model: Processing

| | | |
|---|---|---|
| μ | Contaminant rate | μ = 0 |
| ψ | Filtering efficacy | ψ = 0 |
| | for removal of | |
| | contaminants | |
| δ | Drying protection | δ (Estimated) = 25.0 |
| | period | |
| X_{B} | Bagging | X_{B} = 0 |
| | contamination rate | |

Post-harvest model: A. flavus growth and aflatoxin production

| | | |
|---|---|---|
| η | Contaminant colonisation rate | ${η}_{0} = {β}_{0}^{post}$ |
| β^{post} | Post-harvest A. flavus growth rate | ${β}_{0}^{p o s t} ( Estimated ) = 1.12$ × 10⁻³ |
| τ | Aflatoxin | τ₀ (Estimated) = 5.06 |
| | production rate | |

TABLE 2
Summary of the principal variables, parameters and functions used in the integrated model for the dynamics of
A. flavus growth and aflatoxin production during the supply chain for maize incorporating pre-harvest,
intervention (postharvest) and post-harvest stages.

| Parameters/variables | Symbol | Function / explanation |
|---|---|---|
| | | Pre-harvest fungal and aflatoxin dynamics |
| Sporulation rate | α | α = α₀ (5.28 (T_{eq}(T, 5, 45))^{2.05}(1 − T_{eq}(T, 5, 45)^{0.98} × awₛ^{18.59} |
| | | 5.28 (Teg (T,5,45) |
| Spore liberation rate | λ | λ = λ₀ * dew (RH, ΔRH) |
| Spore deposition | | π₀ * σ |
| proportion | | |
| Spore germination rate | γ | $γ = \{ \begin{matrix}1 & if {aw}_{s} > 0.0004 {T}^{2} - 0.0261 T + 1.2469 \\ 0 & otherwise\end{matrix}$ |
| Host susceptibility (silk availability) | σ | $σ = \{ \begin{matrix}( \frac{1}{4.1 \times {10}^{21}} ) {( {GDD}_{c} - 670 )}^{4.} {( 1700 - {GDD}_{C} )}^{3.9} & for 670 < {GDD}_{c} < 1700 , \\ 0 & otherwise\end{matrix}$ |
| Fungal growth rate (pre-harvest) | β^{pre} | ${β}^{pre} = {β}_{0}^{pre} G ( T , W = a {w}_{i} )$ |
| Aflatoxin | τ | τ = τ₀ K(T, W = awᵢ) |
| production rate (pre- | | |
| harvest) | | |
| | | Post-harvest management interventions |
| Contaminant rate | μ | μ = 0 |
| Filtering efficacy for | ψ | ψ = 0 |
| removal of | | |
| contaminants | | |
| Drying protection | δ | δ (Estimated) |
| period | | |
| Colonisation rate | η | ${η}_{0} = {β}_{0}^{post}$ |
| | | Post-harvest fungal and aflatoxin dynamics |
| Fungal Growth rate (post-harvest) | β^{post} | ${β}^{post} = {β}_{0}^{post} G ( T , W = a {w}_{s} )$ |
| Aflatoxin production rate | τ | τ = τ₀ K(T, W = awₛ) |
| (post-harvest) | | |
| | | State variables that evolve according to model dynamics (pre/post-harvest) |
| Growing degree | GDD | Accumulated Growing degree days (pre-harvest only) |
| days | | GDD (Growing Degree Days) = hourly accumulated integral of the |
| | | instantaneous temperature dependent growth rate, θ |
| | | $θ = \{ \begin{matrix}1.98425 \times {10}^{- 6} ( 41 - T ) {T}^{3.1} & for 0 < T < 41 , \\ 0 & otherwise\end{matrix}$ |
| Conidia in soil | Nₛₒᵢₗ | Current level of viable conidia available in soil (pre-harvest) |
| Conidia on silk | Sₛᵢₗₖ | Current level of viable conidia on silks (pre-harvest) |
| A. flavus | F_{(H, S)} | Aspergillus flavus amount at harvest (H), storage (S) |
| Aflatoxin | A_{(H, S)} | Aflatoxin level (ppb) at harvest (H), storage (S) |
| Contamination | X_{(H, S, B)} | Contaminant amount of A. flavus at harvest (H), storage (S) and from use of |
| | | contaminated bags |
| | | State variables that are not dynamically evolved |
| Location | | Current location of the batch. Used to determine which meteorological data |
| | | should affect the batch. Piecewise constant with a change when moved from |
| | | farm to market |
| Market | | Name of market catchment area the batch resides within. Used to determine |
| | | which market location to move bag to after harvest. |
| Season | | Cropping season for which the batch was planted (e.g., Nizamabad Kharif 2015). |
| | | Used when determining sourcing for factory deliveries. |
| Harvest Date | | Record of the date on which the batch was harvested |
| Drying Protection | | Date up to which the drying process will be effective at stopping A. flavus |
| Date | | growth/aflatoxin production. |
| | | Drying Protection Date = Harvest Date + δ |
| Market Date | | Date on which the batch is moved from the farm to the market. |
| Expiry Date | | Date on which (if not yet sold) the crop will be disposed of. |
| Driving variables | | Meteorological driving variables |
| Temperature (° C.) | T | Hourly temperature measurements |
| Relative humidity | RH | Hourly relative humidity measurements |
| (0-100%) | | |
| | | Derived/Intermediate variables |
| Change in RH over | ΔRH | ΔRHₜ = RHₜ RH_{t-0.5} |
| 30 minutes (%) | | |
| Availability of moisture from dew formation | dew(RH, ΔRH) | $dew ( RH , Δ RH ) = \{ \begin{matrix}1 & if & RH < 70 \\ 0 & if & RH > 87 \\ 1 & if & 70 < RH < 87 and Δ RH < - 2 \\ 0 & if & 70 < RH < 87 and Δ RH > 3 \\ \frac{3 - Δ RH}{5} & if & 70 < RH < 87 and - 2 < Δ RH < 3\end{matrix}$ |
| Ambient moisture | MC | MC(T, RH) = 2.724199 − 0.0774088 T + 0.3480181 RH + |
| content | | 0.001073854 T² − 0.003725816 RH² + |
| | | 0.00002612877 RH³ − 0.001080356 T * RH |
| Ambient water activity | WA | $WA ( MC , T ) = \frac{1}{100} \frac{( log ( MC ) - 2.09 + 0.011 \times T )}{( 0.014 + 0.000049 \times T )}$ |
| Water activity | awᵢ | awᵢ = 1 − e^{-17.2e}^{^{−0.0012*GDD}} |
| within the plant | | |
| Water activity on | awₛ | awₛ = max (WA, dew(RH, ΔRH)) |
| the surface of | | |
| kernels due to either | | |
| ambient water | | |
| activity or dew | | |
| Temperature equivalent, a linearised clamped temperature transformation. | T_{eq} | ${T}_{e q} ( T , {T}_{m i n} , {T}_{m ax} ) = \{ \begin{matrix}1 & if T > {T}_{m ax} \\ 0 & if T < {T}_{m i n} \\ \frac{T - {T}_{m i n}}{{T}_{ma x} - {T}_{m i n}} & otherwise\end{matrix}$ |
| Fungal growth function | G(T, W) | $G ( T , W ) = {( 5.98 {( {T}_{e q} ( T , 5 , 48 ) )}^{1.70} ( 1 - {T}_{e q} ( T , 5 , 48 ) ) )}^{1.43} \times ( \frac{1.12}{1 + {e}^{( 27.37 - 30.08 W )}} )$ |
| Aflatoxin production function | K(T, W) | $K ( T , W ) = {( 4.84 {( {T}_{e q} ( T , 10 , 47 ) )}^{1.32} ( 1 - {T}_{e q} ( T , 10 , 47 ) ) )}^{5.59} \times {e}^{( 30.08 W - 32.8 )}$ |
| Bag Sampling | B(A) | For a given predicted aflatoxin level, A, the bag sampling result, B, is taken as |
| function | | an exponential random variate with mean A: |
| | | $B ∼ exp ( λ = \frac{1}{A} )$ |

Three key biological parameters (the absolute aflatoxin production rate (τ₀), the absolute pre-harvest A. flavus growth rate

$$( {β}_{0}^{p r e} )$$

and the absolute primary A. flavus sporulation rate (α₀), as shown in Table 1 may not be parameterized from pre-existing datasets and these three parameters can be estimated by approximate Bayesian computation using the aflatoxin times series data.

### Harvest Model

At harvest, each batch of maize has an A. flavus (F_{H}) and an aflatoxin (A_{H}) level of contamination calculated from the pre-harvest model. Harvest and removal of maize cobs from plants and separation of the kernels can lead to contamination of the kernels with small particles of potentially contaminated material (leaves, stems, dust) termed “fines.” Removal of these fines by filtering may reduce mycotoxin contamination. The embodiments disclosed herein introduce an additional state variable, X_{H}, where X_{H}=μF_{H}, and the rate parameter μ (Table 1) is included in the parameter set for estimation from the time series data.

The efficacy of different filtering processes and machinery may vary, and the capacity of any given mechanism to remove fines, kernels infested with A. flavus, and kernels contaminated with aflatoxin is unknown (but could be parameterized given appropriate data). The embodiments disclosed herein chose to incorporate filtering into the model framework through the inclusion a parameter ψ, corresponding to the filtering efficacy of the process on the amount of A. flavus, aflatoxin and fines. This can be described by the equations below:

$${F}_{S} = ( 1 - ψ ) {F}_{H} ,$$

$${A}_{S} = ( 1 - ψ ) {A}_{H} ,$$

$${X}_{S} = ( 1 - ψ ) {X}_{H} ,$$

where F_{H} and F_{S} correspond to the level of A. flavus in a batch before and after filtering.

Maize kernels are dried after harvest to reduce internal moisture content levels below the threshold at which A. flavus can both grow and produce aflatoxin. Air drying by spreading maize kernels on the ground for exposure to the sun is common in low- and middle-income countries with mechanical drying in more intensive systems. In the absence of detailed information, the drying protection period (δ) was treated as a parameter to be estimated from time series data for aflatoxin contamination at the factory gate. The embodiments disclosed herein assume that drying interrupts fungal growth and toxin production, hence the A. flavus bulk-up and aflatoxin rates are set to zero in the model during estimated drying protection period.

In India, maize is generally stored in 50-60 kg jute bags after harvesting and drying. The bags may be reused from season to season without effective cleaning, and so provide an additional source of inoculum at bagging time. The embodiments disclosed herein incorporate contamination from bags by allowing an additional amount of fines (X_{B}) to be added to the post-harvest contaminants (X_{H}).

For the purposes of fitting the integrated model to the time series data for aflatoxin levels at the factory gate (see below), the embodiments disclosed herein estimate the drying delay period (δ), but in the absence of additional information the embodiments disclosed herein treat the contaminant (μ), bag contamination (X_{B}) and filtering (ψ) rates as fixed at zero (Table 1).

### Post-Harvest Model

The post-harvest model can extend from harvest to delivery to a factory, during which the material is in storage either on the original farm or at a market. The post-harvest model can introduce the potential for controlled storage conditions, in which the environmental conditions are modulated with consequent effects on A. flavus and aflatoxin production. The embodiments disclosed herein assume that harvest processing precedes the start of storage. Each batch is therefore initially characterized by A. flavus, (F_{S}), aflatoxin, (A_{S}) and contaminant (X_{S}) concentrations.

The post-harvest component of the model can comprise two processes. Firstly, tracking A. flavus and aflatoxin levels in stored maize (again using environmental weather data to drive the biological processes). Secondly simulating the sourcing and sampling process of maize at the factory gate in order to allow for matching of the model output to the available aflatoxin time series data.

The post-harvest epidemiological model is described by the following discrete time equations. Parameters are described in

Table 1 and Table 2.

$${X}_{t + 1} = {X}_{t}$$

$${F}_{t + 1} = {β}_{t}^{p o s t} ( {F}_{t} + {X}_{t} ) ( 1 - {F}_{t} )$$

$${A}_{t + 1} = {A}_{t} + {τ}_{t} {F}_{t}$$

Growth of A. flavus on the maize kernels occurs from A. flavus present on the kernels (F) or from other contaminant material (fines) within the bag (X). The embodiments disclosed herein assume a similar functional form for the A. flavus growth rate as for pre-harvest but with a different scaling parameter

$$( {β}_{0}^{p o s t} ) .$$

Here the water activity, awₛ (see Table 2), is determined by ambient humidity levels, rather than the internal moisture content of the plant or crop. The water activity, awₛ, is taken to be the maximum of the water activity due to humidity and dew point. The parameter

$${β}_{0}^{p o s t}$$

is obtained by fitting the integrated model to time series data (Table 2).

The post-harvest aflatoxin production rate (τ) follows the form as for the pre-harvest model with water activity now related to ambient humidity levels. The rate constant τ₀ is common between the pre- and post-harvest models, as the fitting process determined separate rate constants provided no significant benefit.

The majority of maize in India is stored for several months, potentially up to a year, in non-climate-controlled spaces where it is exposed to ambient temperature and moisture conditions, which permit continued growth of A. flavus and aflatoxin production. However, some storage facilities are climate controlled. Controlled storage conditions can affect temperature, relative humidity and oxygen tension. The embodiments disclosed herein therefore permit the model to adjust the temperature and humidity as specified for the storage where this is known. The embodiments disclosed herein allow for different storage conditions over the supply chain, with material stored on the farm and at market potentially having different storage conditions. In India, maize is typically stored on the farm for the first 30 days before being moved to the markets. The model can reflect this, with batches being stored on the farm for the first 30 days after harvest, subject to the environmental conditions (and any controlled storage conditions) at that location before being moved to the market. Once arrived at the market, batches can be selected by the sourcing process to be sent as shipments to the factory.

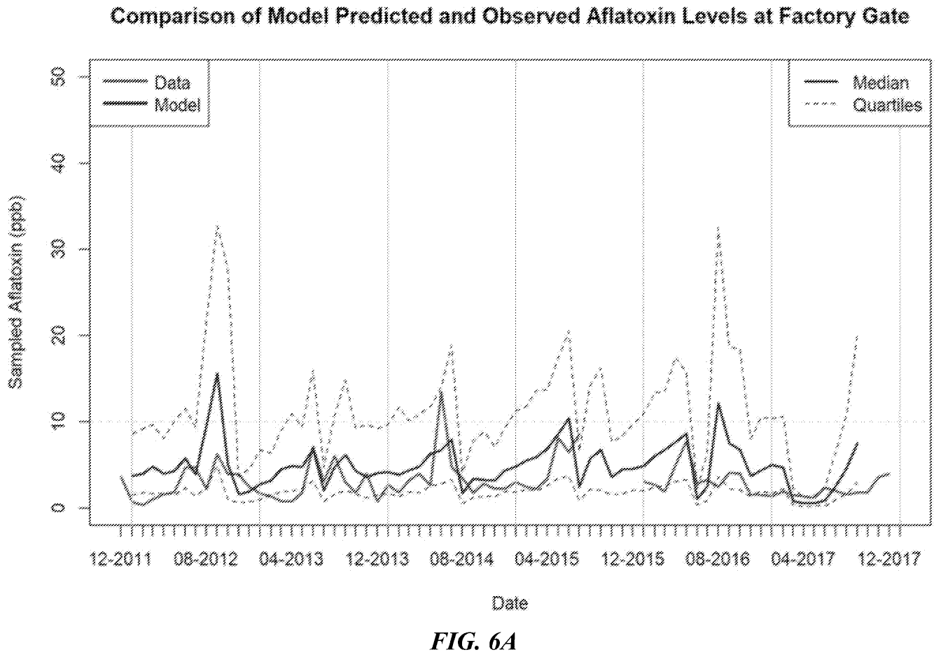

Further details of the model are illustrated in FIG. 4. The schematic diagram in FIG. 4 describes the pre-harvest, processing (e.g., a harvest model) and post-harvest integrated model for A. flavus growth and aflatoxin production on a postulated batch of potential maize kernels in the supply chain. Herein, Nₛₒᵢₗ represents the number of spores in the soil and Sₛᵢₗₖ represents the number of spoon the silks of the maize plants. The F state variable represents the level of A. flavus infection within the maize kernels. The A state variable represents the amount of aflatoxin within the kernels. X represents the amount of A. flavus present on contaminant material (fines) within bags. Subscripts H and S denote the values of the state variables at the time of harvest and entering storage, respectively. The key parameters are summarized in Table 1 and Table 2. Other parameters shown in FIG. 4, such as α, λ, γ, τ, β^{pre}, β^{post}, σ, π, ψ, θ and η are summarized in Tables 1 and 2.

In particular embodiments, the harvest processing model can incorporate common cultural control practices. The embodiments disclosed herein include drying, filtering and bagging of maize kernels after harvest to improve flexibility for scenario testing of alternative control scenarios.

### Statistical Parameter Approximation

Two key biological parameters (the absolute aflatoxin production rate (τ₀—a common parameter with pre-harvest model), and the absolute post-harvest A. flavus growth rate

$$( {β}_{0}^{p r e} ) )$$

could not be parameterized from pre-existing datasets so were estimated by approximate Bayesian Computation using the aflatoxin times series data.

The available data included multiple samples from the same shipment. The high observed variance between successive samples from the same batch indicated the need to simulate the sampling process to capture this source of variability in order to make a fair comparison between model and historical observations. Hence, the model predicted aflatoxin values (A) can be subjected to a simulated sampling process to obtain a value for comparison to historical data (B) by the following procedure:

$$B ∼ exp ( λ = \frac{1}{A} ) ,$$

where exp is the exponential distribution with mean 1/λ.

In particular embodiments, five parameters can be determined using approximate Bayesian computation. As there are no data available for intermediate stages in the supply chain, the embodiments disclosed herein therefore compared the model predictions with daily data recorded at the processing plant. Fitting was performed on data for 2012-2015, with 2016-2017 retained for validation. The key parameters to be estimated are primary A. flavus sporulation rate, pre-harvest A. flavus growth rate, post-harvest A. flavus growth rate, aflatoxin production rate and drying protection duration (Table 1).

The embodiments disclosed herein sample a set of model parameters, η, independently from a constrained uniform prior distribution for each of the five parameters. The model can be then run over a given time range (years 2012-2015, the “fitting period”) with these parameters and a time series of delivery aflatoxin levels can be generated. The model delivery aflatoxin timeseries can be aggregated by month and the 75^{th} percentile of the sampled aflatoxin levels can be compared with the aggregated monthly observed data for aflatoxin levels using the following fitting metric, E.

$$E ( η ) = \frac{1}{n} {\sum }_{\begin{matrix}months i \\ in fitting \\ period\end{matrix}} {( \sqrt{{O}_{i}} - \sqrt{{M}_{i} ( η )} )}^{2}$$

where Oᵢ and Mᵢ(η) are the 75^{th} percentile of aflatoxin values for month i for the observed data and model predictions (given parameters η), respectively, and n is the number of months in the fitting period. Note that as the model is stochastic, multiple realizations with the same parameters (η) can give different results, and thus a distribution of values for E(η). The square root transformation was chosen for variance stabilizing properties.

The posterior distribution was generated from 750,000 parameter samples, accepting the top 1% of parameter samples according to the fitting metric, and rejecting the remainder. The parameter space can be then cut into 5-d boxes and the likelihood for parameter values within each box can be calculated as the number of acceptances out of the total number of samples performed in that box. Given the uniform prior, this acceptance rate can be then taken as the posterior probability distribution. The values of epidemiological parameters selected from the posterior distribution for use in the model are recorded in Table 1.

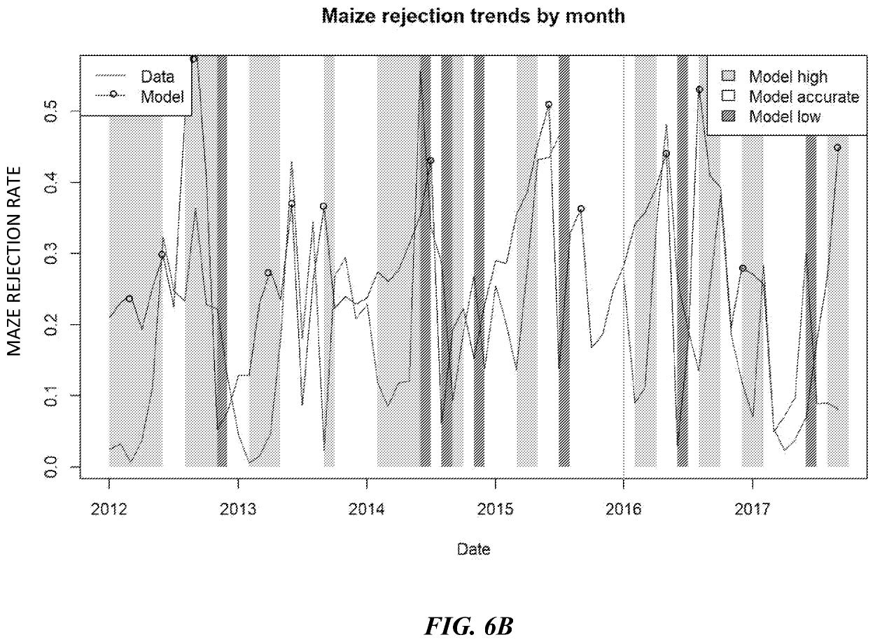

For all parameters except the aflatoxin production rate (τ) the prior was uniform over independent intervals with bounds as shown in Figure FIG. 5. These bounds were chosen based on preliminary simulation runs. The choice was made not to explore values for the post-harvest aflatoxin growth rate (β^{post}) below log(β^{post})=−4 as below this value there is effectively no post-harvest aflatoxin growth, and this was deemed biologically implausible. Due to the linear effect of τ, this parameter was chosen by first sampling all other parameters from the prior and running a simulation with these parameters and a value of τ=1. The actual value of τ was then obtained via choosing via interval bisection a rescaling for the simulated aflatoxin values such that the fitting metric E was minimized. Further exploration of the τ dimension was achieved by taking a sample of 20 values of τ around the obtained optimum ranging from half to double the optimal value. The choice to sample τ in this way was made in order to reduce the effective dimensionality of the parameter space being searched, greatly reducing computation resources needed to achieve a given useful sampling density.

The fitting process has established bounds for the model parameters. Some parameters are correlated, and with more data it may be possible to disentangle and further constrain the parameters. The data required to achieve this would require monitoring at other points in the supply chain prior to final delivery and information on A. flavus levels.

While model A. flavus levels are within reasonable bounds, the effect of the primary sporulation rate (α) and aflatoxin production rate (τ) is relatively linear, allowing these parameters to trade off against each other freely, setting the scale of A. flavus values. The pre-harvest aflatoxin growth rate (β^{pre}) also has a relatively simple ratio effect while A. flavus levels remain in the exponential growth phase, explaining the trade-off with α. Having information about A. flavus levels at multiple points in the life cycle of a batch, optimally at the start and end of storage, would constrain A. flavus levels and allow these trade-offs to be eliminated, much more tightly constraining these parameters. While these additional data would significantly constrain parameters and model A. flavus predictions, it would not constrain or change model aflatoxin outputs significantly, as the aflatoxin levels are again linearly scaled by τ and thus any values of α and (to a reasonable degree) β^{pre} can be compensated for by τ.

Fitting independent aflatoxin production rate parameters for the pre-

$$( {τ}_{0}^{p r e} )$$

and post-harvest

$$( {τ}_{0}^{p o s t} )$$

model components was attempted, but model performance was unchanged and the aflatoxin production rate parameter values were highly correlated along the line

$${τ}_{0}^{p r e} = {τ}_{0}^{p o s t} .$$

Hence, without a biological motivation to separate these rate parameters, a decision was made to use a common aflatoxin production rate parameter in order to reduce the dimensionality of the parameter space and reduce computational requirements.

FIG. 5 illustrates an example visualization of the 5-parameter posterior distribution obtained from the approximate Bayesian computation fitting of the model to historical data from the years 2012-2015. The subplots show all unique pairwise combinations of two-dimensional projections of the 5-parameter distribution. While parameter values are sampled continuously during the fitting process, the parameter acceptance rate is calculated here as the average of all samples contained within discretised boxes. The quantisation used for each parameter is as follows: Δ log(α)=0.3, Δ log(β^{pre})=0.1, Δ log(β^{post})=0.1, Δ log(τ)=0.55, Δδ=3.

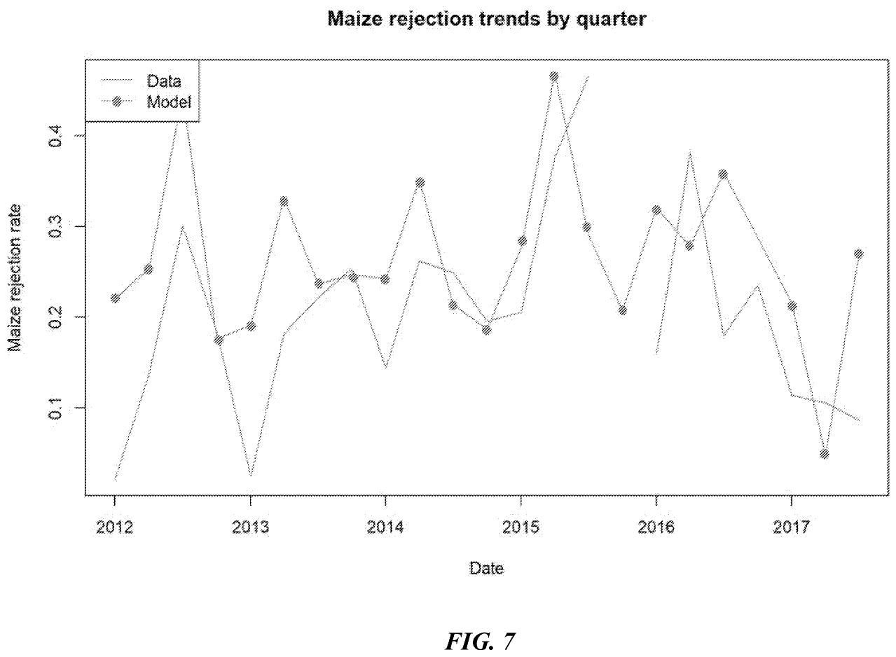

The fitted model can be then validated against data from the years 2016-2017 (the “validation period”). The computing system can calculate descriptive statistics (monthly median aflatoxin concentration and monthly average shipment rejection rate) to characterize the model performance for the validation period relative to the fitting period. The parameterized model outputs are compared to the model predicted monthly shipment rejection rates with the historical data monthly rejection rates. Each month the model prediction may be classified as “Low”, “Accurate” or “High” if it is more than 10% below, within 10% of or more than 10% above the historical data rejection rates. This classification was performed for the parametrized model fitting, and validation. Various comparison results between the parameterized model and historical data are shown in the FIGS. 6A-11, FIGS. 13A-14B, and FIGS. 18-21 as further discussed below.

### Model Comparison with Historical Data

Approximate Bayesian computation allows estimation of five epidemiological parameters for the integrated pre- and post-harvest model, using data for aflatoxin levels in batches arriving at a processing factory. The fitting established plausible bounds on all parameters. The posterior distribution for the drying protection duration (δ) was particularly well defined within an estimated range of 10-35 days independent of other parameter values. There are trade-offs amongst certain parameter posterior distributions with correlations between the primary sporulation rate (α) and the pre-harvest bulk up rate (β^{pre}) as well as the primary sporulation rate (α) and the toxin production rate (τ). These correlations may be consistent with the lack of observational data for A. flavus levels throughout the supply chain, other than for sourcing regions. The final aflatoxin levels may be predicted accurately by sampling from the combined posterior distributions.

Model performance

| | Low | Accurate | High |
|---|---|---|---|
| [1] Dataset | (−4 ppb) | (±4 ppb) | (+4 ppb) |
| Fitting period | 4.7% | 83.7% | 11.6% |
| (2012-2015) | | | |
| Validation period | 0.0% | 85.7% | 14.3% |
| (2016-2017) | | | |
| Total period | 3.1% | 84.4% | 12.5% |
| (2012-2017) | | | |

Table summarizes the model performance in matching monthly median aflatoxin levels. Monthly median aflatoxin levels for the model were classified as: accurate if they were within ±4 ppb of the observed monthly rejection rate, low if 4 ppb or more below, and high if 4 ppb or more above. The model performance was consistent across the data for the training period (2012-2015) used for fitting and the validation period (2016-2017), giving an accuracy of approximately 85% for being within ±4 ppb of the validation data. The model is more likely to overpredict than underpredict median aflatoxin levels, indicating the model is less likely to underpredict a period of high risk (false negative) than to overestimate risk during low-risk times (false positive).

TABLE 3
Descriptive statistics of model performance: Monthly model outputs
classified as Low, Accurate, or High if the model predicted median
aflatoxin levels is more than 4 ppb below, within 4 ppb of or more
than 4 ppb above, respectively, relative to the historical observed
median aflatoxin level. The table summarizes the proportion of
months with each classification for the respective dataset.

Model performance

| | Low | Accurate | High |
|---|---|---|---|
| Dataset | (−4 ppb) | (±4 ppb) | (+4 ppb) |
| Fitting period | 4.7% | 83.7% | 11.6% |
| (2012-2015) | | | |
| Validation period | 0.0% | 85.7% | 14.3% |
| (2016-2017) | | | |
| Total period | 3.1% | 84.4% | 12.5% |
| (2012-2017) | | | |

Predicted rejection rates may be obtained by assessing the monthly proportion of aflatoxin values from model outputs that exceeded the 10-ppb threshold. The rejection rates follow the broad trends of historical rejection rates, capturing periods of high rejection rates, although the model does typically predict slightly higher rejection rates in periods that were historically low. The model performance in matching the monthly shipment rejection rates at the processing factory is summarized in

Table Error! Reference source not found. Monthly rejection rates for the model were classified as: accurate if they were within ±10% of the observed monthly rejection rate, low if >10% below, and high if >10% above. The model performance was consistent across the data for the training period (2012-15) used for fitting and the validation period (2016-17), giving an accuracy of approximately 50% for being within ±10% of the validation data. The model is significantly more likely to overpredict than underpredict rejection rates, indicating the model is much less likely to underpredict a period of high risk (false negative) than to overestimate risk during low-risk times (false positive). Overall, model overestimation of rejection rates is driven predominantly by periods when the historical rejection rates were low, as shown in FIG. 6B, for example, for a summer of 2016.

TABLE 4
Descriptive statistics of model performance: Monthly model outputs
classified as Low, Accurate, or High if the model predicted monthly
rejection rate is more than 10% below, within 10% of or more than
10% above, respectively, relative to the historical observed monthly
rejection rate. The table summarizes the proportion of months with
each classification for the respective dataset.

| | Model performance | | |
|---|---|---|---|
| | Low | Accurate | High |
| Dataset | (<10%) | (±10%) | (>10%) |
| Fitting period | 9.3% | 51.2% | 39.5% |
| (2012-2015) | | | |
| Validation period | 9.5% | 52.4% | 38.1% |
| (2016-2017) | | | |
| Total period | 9.4% | 51.6% | 39.0% |
| (2012-2017) | | | |

FIG. 6A illustrate example time series for the model output (based upon an optimal selection of parameters). The embodiments disclosed herein first observe that the model performance is consistent across all datasets, indicating the model is able to replicate the behavior of the system, rather than overfitting to observed data.

FIG. 6A show a comparison of model predicted and observed aflatoxin levels in shipments received at the maize processing plant in Hyderabad. Data were received from Kharif and Rabi crops grown in up to three sourcing regions (Bellary, Guntur and Nizamabad) during 2012-2017. The integrated model, as shown in FIG. 6A, replicated broad trends in the time-series for the median and quartiles aflatoxin levels. The data obtained using the integrated model is compared with the observed data corresponding to the median of the monthly historical aflatoxin values. The model correspondence to historical data is consistent across the fitting (pre-2016) and validation (2016-2017) time ranges. The model predicts the magnitudes and timings of annual peaks as well as monthly fluctuations in aflatoxin levels. The 10 ppb aflatoxin rejection threshold is marked by a horizontal dashed line, as shown in FIG. 6A. Further, the medial prediction of the model, as shown in FIG. 6A, replicates broad trends in median aflatoxin levels, including typical scale and timings of annual peaks in aflatoxin levels. The model also captures the width of the distribution on a month-by-month basis, as well as the variable nature of the month-to-month changes in aflatoxin levels. In terms of predicting the highest peaks in the data, the model is accurate with the highest peaks in 2013 and 2015, but overestimates at a highest peak in 2012 and underestimates at a peak in 2014.

FIG. 6B shows a comparison of model predicted and historically observed monthly rejection rates for shipments at the factory gate. The light grey shading indicates where the model is classified as too high (over 10% above the observed rejection rate) and the dark grey shading where the model is classified as too low (over 10% below the observed rejection rate). The divide between the periods used for fitting and validation data is denoted by the green vertical line. FIG. 6B shows that the model predicted rejection rates are similar to the observed rejection rates and follow the same annual cycle of peaks and troughs. The model also displays a similar month to month variability to the observed data. The data and the model simulations show marked variability in the monthly levels of aflatoxins. These reflect variability in sourcing from the Kharif and Rabi cropping seasons grown in up to three sourcing regions, with variable periods of storage between harvest and supply.

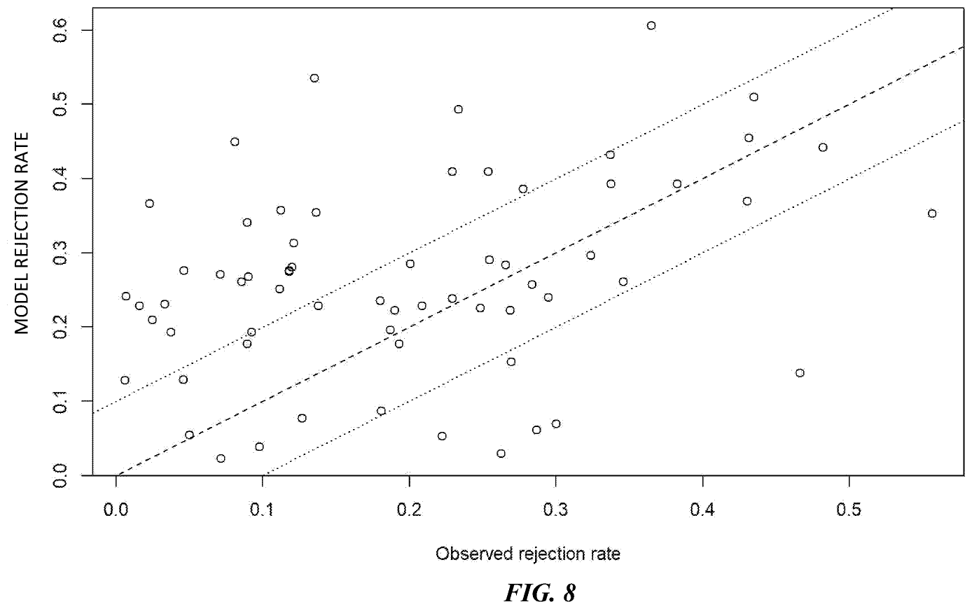

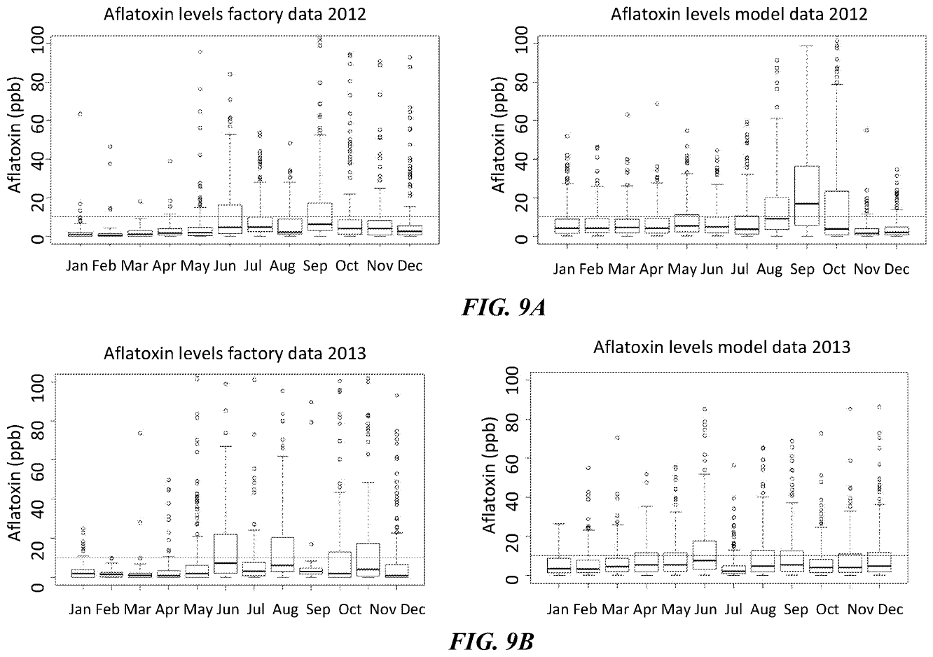

FIG. 7 illustrates maize rejection rates aggregated on a quarterly basis, comparing both the model and historical data. The rejection rate is represented as a fraction of the maize batches rejected in relation to the total collected. In FIG. 8, an alternative method of comparing the model's predicted rejection rates with historical data is shown through a scatterplot of monthly rejection rates. The dashed line indicates when the model's monthly rejection rate matches the historical data's monthly rejection rate, while the dotted lines delineate the +/−10% tolerances utilized to categorize the model results for descriptive statistics.

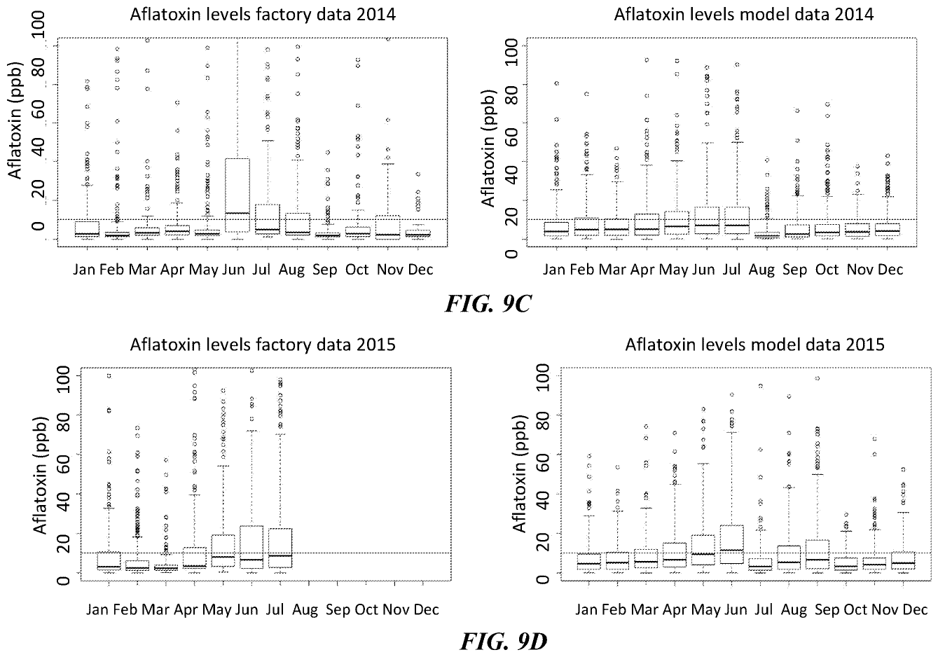

Additionally, the model is compared with historical data for aflatoxin observations at the factory gate in FIGS. 9A-9F. These figures depict aflatoxin boxplots that compare the monthly distributions of historical aflatoxin observations at the factory gate with the model's predicted monthly aflatoxin distributions for the years 2012-2017. The horizontal line represents the 10-ppb rejection threshold, while any outlier values are depicted as individual points lying outside the 95% whiskers.

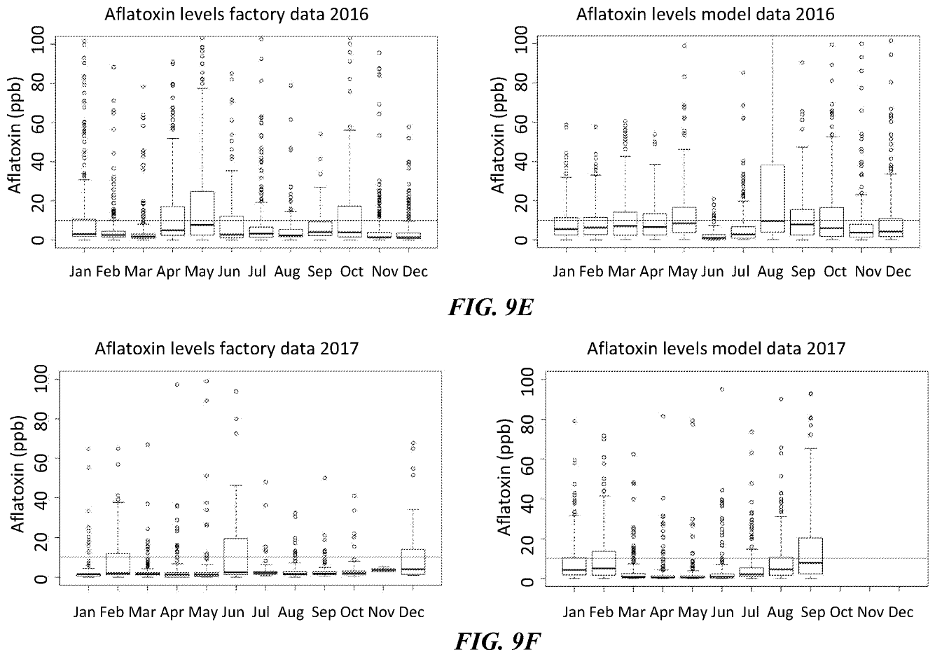

FIG. 10 illustrates model median confidence interval obtained from 100 independent replicates sampling parameters from the posterior distribution. The line 1010 represents the median of the monthly historical aflatoxin values. The line 1020 represents the median of the hundred model replicate median aflatoxin values for each month, and the lower and upper dotted lines represent the bounds of the 5^{th} and 95^{th} percentile of model median monthly aflatoxin values, respectively.

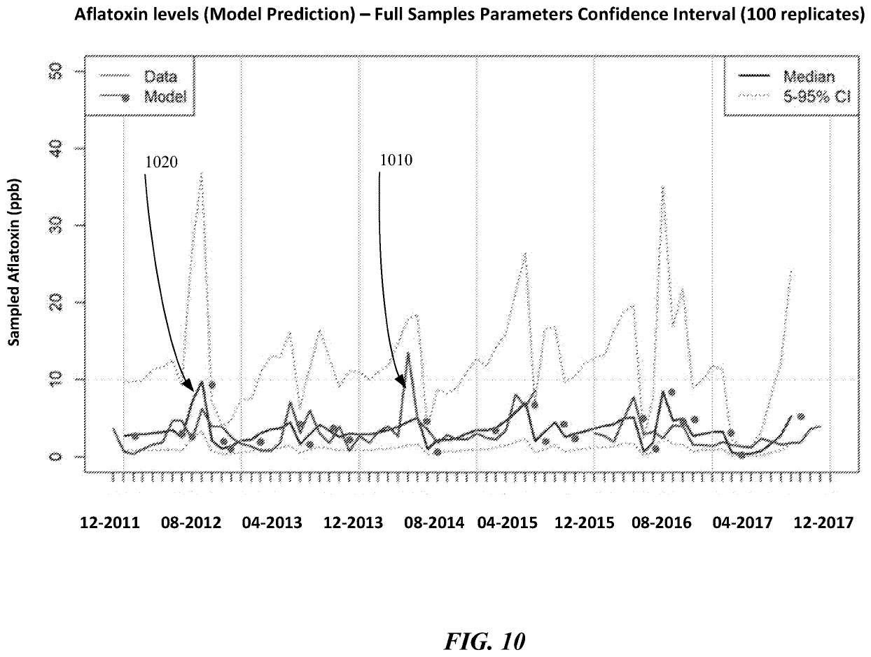

FIG. 11 illustrates confidence intervals on model predicted rejection rates generated from an ensemble of 100 independent model realisations, sampling from the posterior parameter distribution. The confidence interval is generated for each month by taking the 5^{th} and 95^{th} percentile of model rejection rates for that month.

### Model Predictions

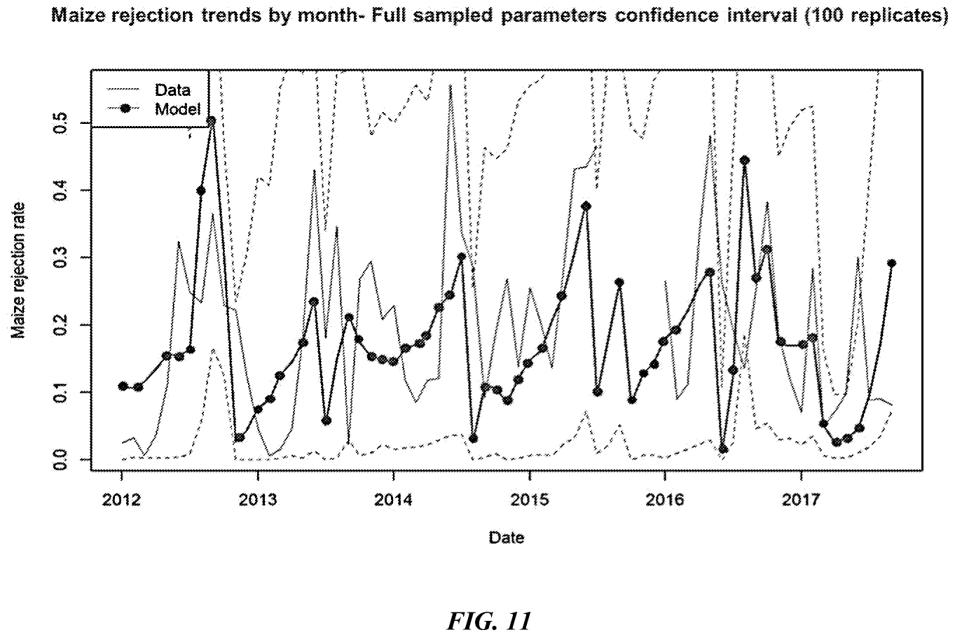

To provide further insight and understanding of the A. flavus growth and aflatoxin production, the model can be used to investigate general trends within and between regions and cropping seasons. The growth rate of A. flavus within different regions can be collected, as shown, for example in maps of FIGS. 12A-12C that illustrate maps for average relative A. flavus growth rate

$$( {β}^{post} / {β}_{0}^{post} )$$

and relative aflatoxin production rate (τ/τ₀) in three sourcing location in India, Nizamabad, Guntur, and Bellary. FIG. 12A show the annual average of hourly relative A. flavus growth and FIG. 12B shows the annual average aflatoxin production rates for years 2012-2017. The monthly spatial and temporal A. flavus growth is shown in FIG. 12C. Note the different scales for the monthly and annual plots, with peak monthly average increase in the growth of A. flavus being approximately twice that of peak annual average growth. While there are spatial trends and variations in A. flavus growth, there is significant variability in the growth over different time intervals and durations, with the possibility of periods of high growth over short time intervals in locations not identified from annual averages. For example, FIG. 12C shows that there is a high monthly average A. flavus growth during months of August, September, and November, while there is low monthly average A. flavus growth during months of January-June.

In general, growth rates of A. flavus in FIG. 12A-12C indicate that there is a high A. flavus growth and aflatoxin production along the coast near Guntur, while there is only moderate A. flavus growth inland. However, for some of the months (e.g., for the months of September and August, as shown in FIG. 12C, there is a significant growth of A. flavus in Nizamabad region. This variability highlights the necessity of considering both the location as well as the time at which maize is grown and stored when assessing aflatoxin risk. The areas suitable for aflatoxin production are typically a subset of those suitable for A. flavus growth, reflecting the assumption that conditions for aflatoxin production follow the same form as A. flavus growth with stricter constraints.

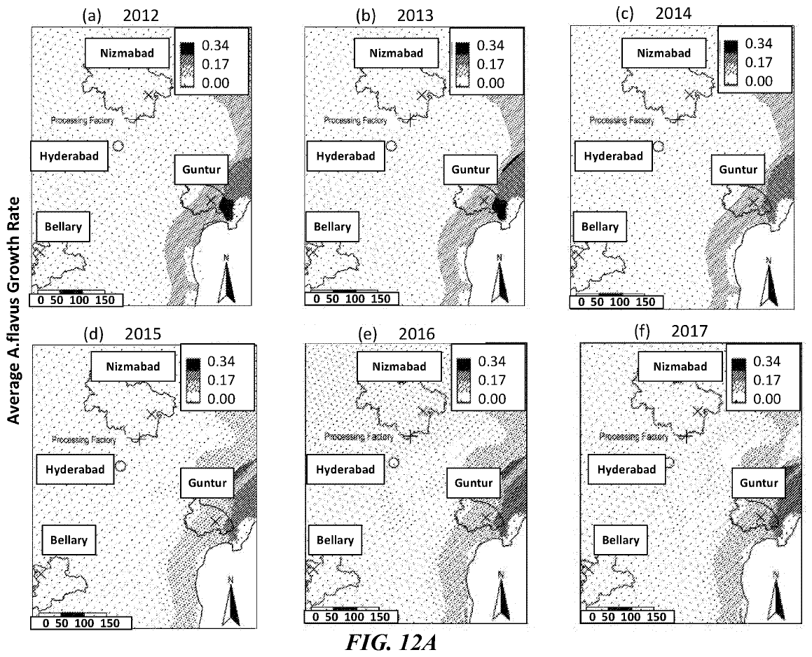

FIGS. 13A and 13B show box plots depicting averaged yearly growth rates for A. flavus within the Nizamabad region, for Kharif (FIG. 13A) and Rabi (FIG. 13B) harvests. Note that Rabi harvests are predicted to have significantly lower A. flavus growth than Kharif harvests, demonstrating also significantly lower variability both within and between years. These types of result can allow users of the integrated mechanistic model to get an overview of the general behavior of the system and investigate any relationships of interest.

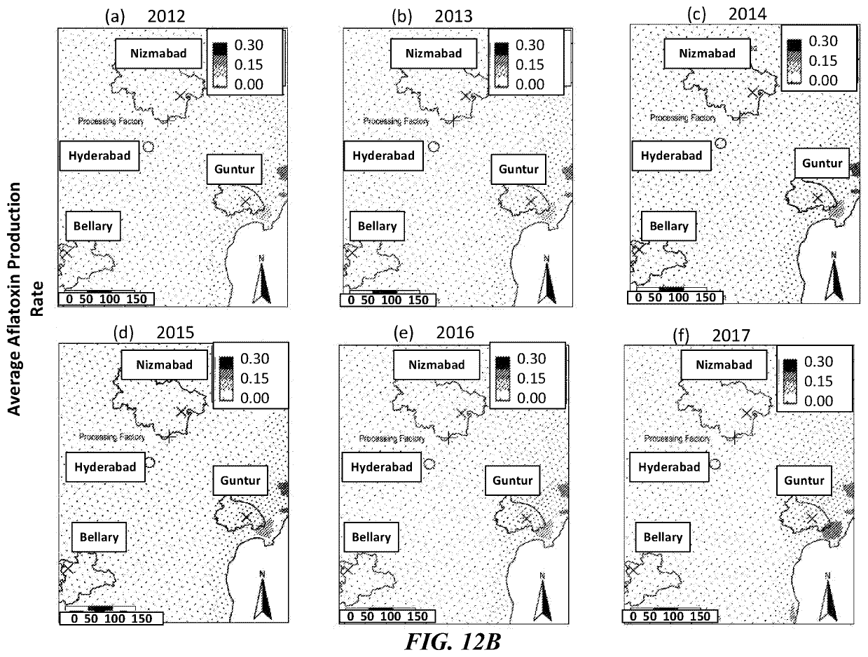

FIG. 14A-14B illustrate time course for A. flavus colonization and aflatoxin production for three selected batches of maize in each of three sourcing regions, Bellary, Guntur and Nizamabad for the 2012 Kharif growing season with storage extending into 2013. The fitted model may be used to gain an understanding of the behavior of the overall system, with insight into predicted levels of A. flavus and aflatoxin in batches over time from planting through to storageError! Reference source not found. FIG. 14A-14B focus on a single cropping season, the 2012 Kharif harvest, and show three individual batches from each of the three sourcing regions; however, the same analysis could be performed on any set of batches from any time periods and locations.

FIG. 14A-14B indicate a consistent trend amongst sourcing regions with A. flavus colonization increasing rapidly during the maize growing season (June-September 2012) up till harvest, after which substantial A. flavus occurs (FIG. 14A) Aflatoxin levels increase over time, with most aflatoxin production occurring in the storage phase and very significant increases when left in storage for a long time (FIG. 14B). In the Kharif cropping season using the historic weather data for 2012, the Nizamabad region consistently shows the highest A. flavus levels both pre- and post-harvest, followed by Guntur and then Bellary. While the general trend is for batches from the Bellary region to have lower A. flavus and aflatoxin levels than batches from other regions, one batch in Bellary was significantly more contaminated with A. flavus. During storage the A. flavus levels in this batch continue to grow and remain the highest out of all in the tracked batches from Bellary. Aflatoxin levels within this batch are initially the highest out of all tracked batches, however, despite the high A. flavus levels, aflatoxin concentration after a year in storage is lower than four of the nine tracked batches as conditions at the market storage location are not as conducive as at other markets. The different environmental conditions within and between regions can lead to significant differences and divergences in A. flavus and aflatoxin levels over time. While batches are dispersed over the region at different farms during the pre-harvest maize growing phase, batches within a region can be subject to different environmental conditions, allowing for a range of different batch statuses by the time of entering storage. Once in storage, batches stored in the same market location may be subject to the same environmental conditions, and hence follow similar trends thereafter. Higher A. flavus levels at time of entering storage led to higher A. flavus growth rates within storage, and these A. flavus levels are the drivers of aflatoxin production during conducive conditions in storage. In some embodiments, while the pre-harvest phase does not directly produce as much aflatoxin as long-term storage, it is the final pre-harvest state of a batch determines the initial state in storage, and thus how much aflatoxin will be produced if suitable conditions occur. Additionally, the pre-harvest condition is important for accurate predictions of aflatoxin levels in batches delivered after a short period of storage. In addition to delivering insight into the life history of individual batches, the model may be used to look at regional trends in distributions of A. flavus and aflatoxin over many years.

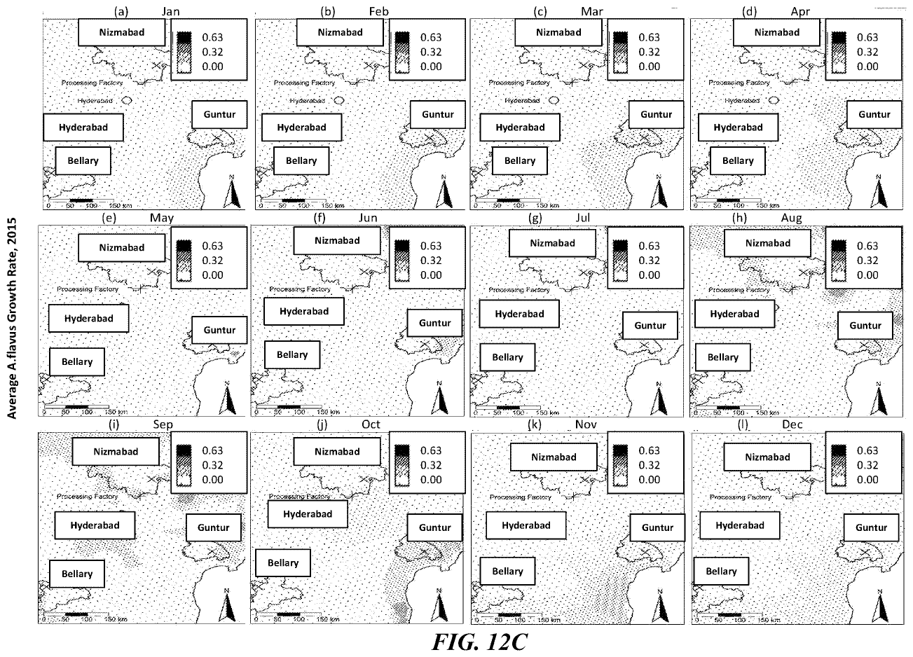

FIG. 15 illustrates example risk maps for A. flavus growth rates in Bellary, Guntur and Nizamabad regions. The risk maps indicate how the A. flavus growth changes spatially over these regions due to humidity and temperature.

### Sourcing and Mitigation

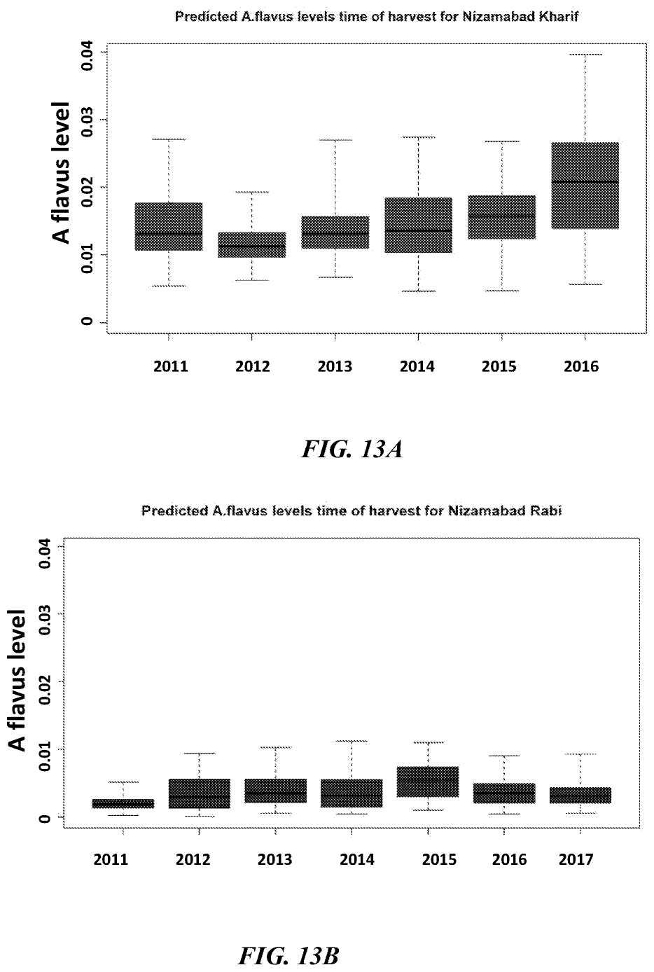

As previously described, a computing system (e.g., system 200 or 201, as depicted in FIGS. 2A and 2B) can employ a predictive model (e.g., predictive model 224) to calculate the probable aflatoxin levels for stored material that could be sourced, based on recent weather data. For instance, in FIG. 16, we observe the projected aflatoxin levels in the Kharif 2016 crop stored in the Nizamabad region (1710) from August 2016 to June 2017 in the context of Nizamabad Kharif harvests from the previous four years (1720, 1730, 1740, and 1750). These forecasts enable users to assess the risk associated with a particular sourcing region compared to previous years. In most years, the predicted aflatoxin levels are too high for sourcing by the following March, but in some years, the material is anticipated to remain clean enough for use until the following June. The target year 2016 (1710) begins similarly to the previous four years but is projected to become the most contaminated as time progresses in storage. The hypothetical user decision point is marked by the dotted vertical line (1760). Concentration lines described by aflatoxin levels 1720-1755 beyond that point may exhibit aflatoxin levels too high for sourcing in subsequent months. The horizontal dashed line (1762) represents the 10-ppb rejection threshold.

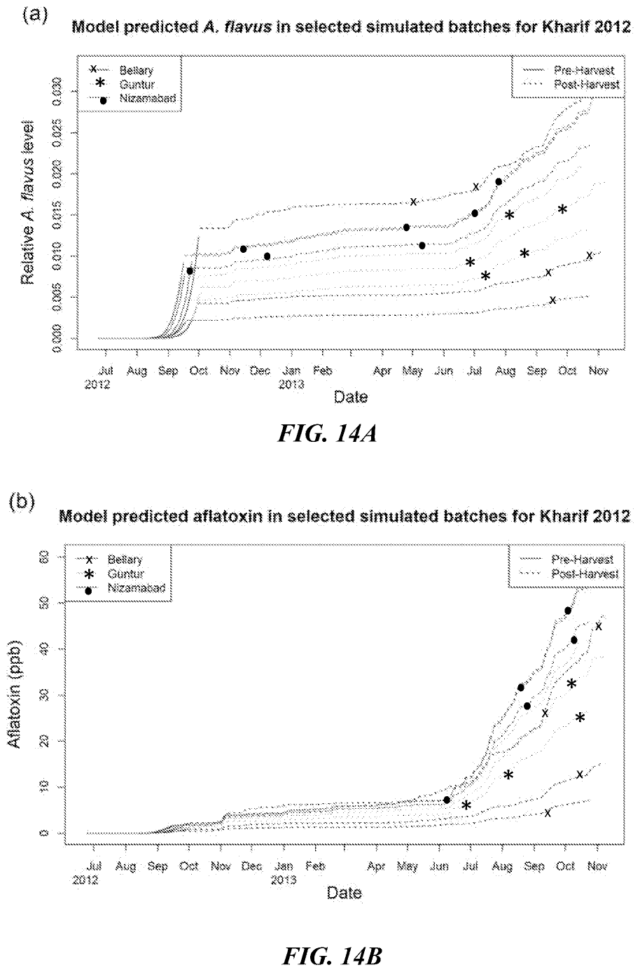

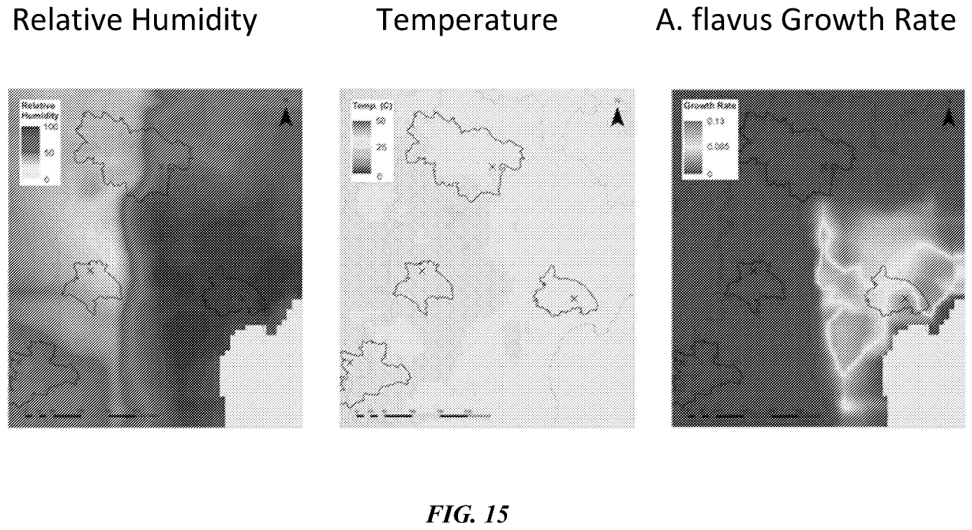

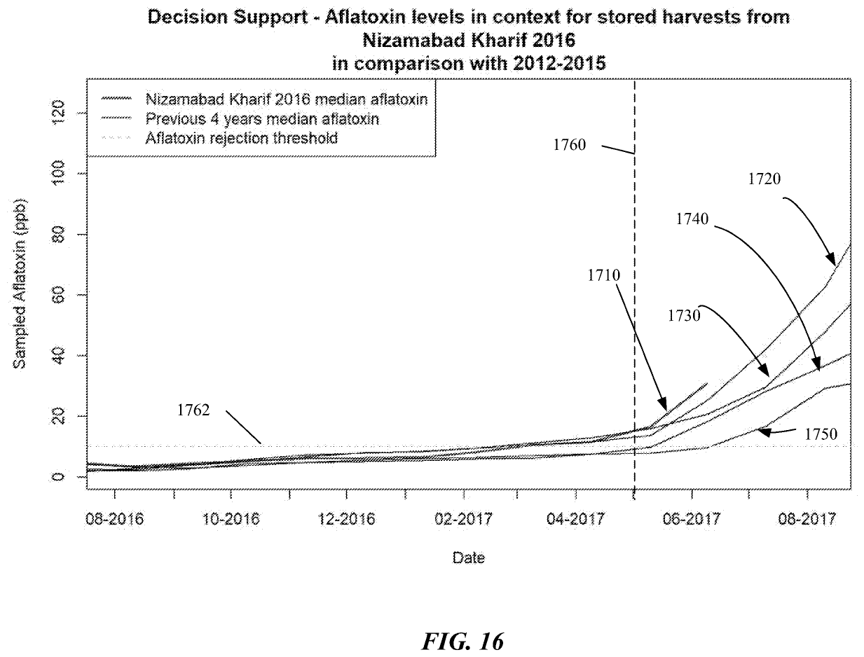

FIGS. 17A-17B illustrate example time profiles of A. flavus/aflatoxin growth in stored batches of crops, and FIGS. 18, 19A-19B, and 20A-21 illustrate example model prediction analysis using a predictive model with parameters fitted using historical data. The computing system can use the model to predict the effectiveness of interventions, e.g., how does planting date affect aflatoxin levels, how does adding in various levels of control affects aflatoxin levels, and what would a different sourcing strategy look like. FIG. 18 shows the predicted aflatoxin levels at harvest conditional on sowing data for Nizamabad Kharif 2016 crops.

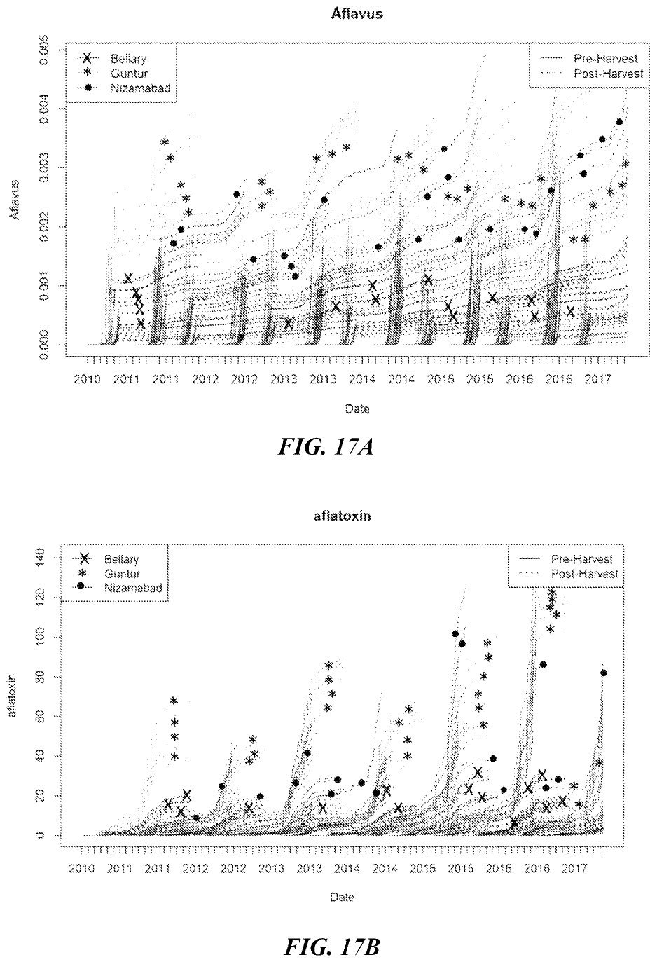

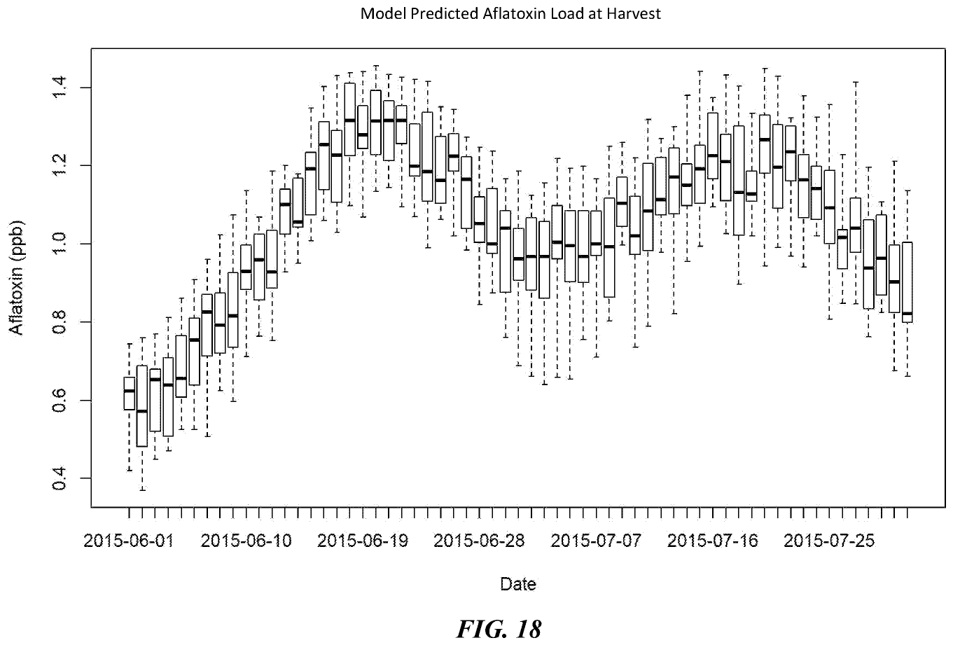

FIGS. 19A and 19B illustrate the impact of mitigation actions, such as filtering and adjustments in temperature during the storage of maize kernels, on the aflatoxin levels in the maize kernels.

For instance, in FIG. 19A, we compare the baseline model predictions (graph 1910) for median aflatoxin levels at the factory gate with no intervention to the predictions represented by graphs 1920 and 1930. These show the expected levels of aflatoxin when filtering is universally adopted with 50% and 95% effectiveness, respectively. Filtering consistently demonstrates a positive effect on reducing factory gate aflatoxin levels, with greater effectiveness yielding more significant reductions. The most substantial reductions in aflatoxin levels occur when the initial levels are highest. For instance, the aflatoxin concentration may drop from a high value of around 10 ppb to a low value of a few ppb or less, as depicted in FIG. 19A.

In FIG. 19B, the baseline model predictions for median aflatoxin levels at the factory gate with no intervention (1940) are compared with the predicted level of aflatoxin that would be observed with the universal adoption of market storage facilities cooled by 5° C. below ambient temperatures (1950) and 10° C. below ambient temperatures (1960). As seen from FIG. 19B, such mitigating actions can dramatically reduce aflatoxin contamination from high values of 10 ppb or more to low values of a few ppb or less.

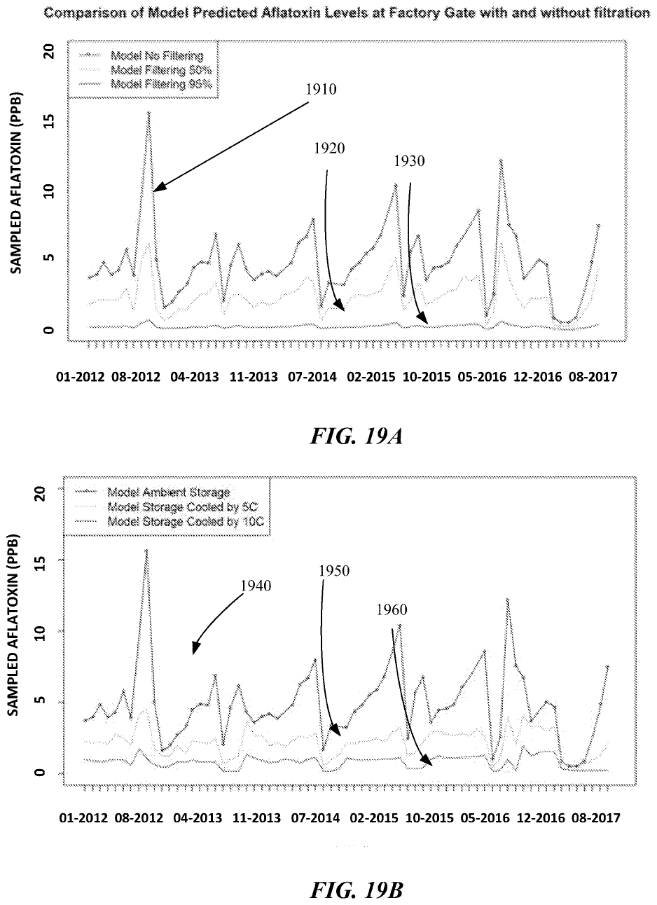

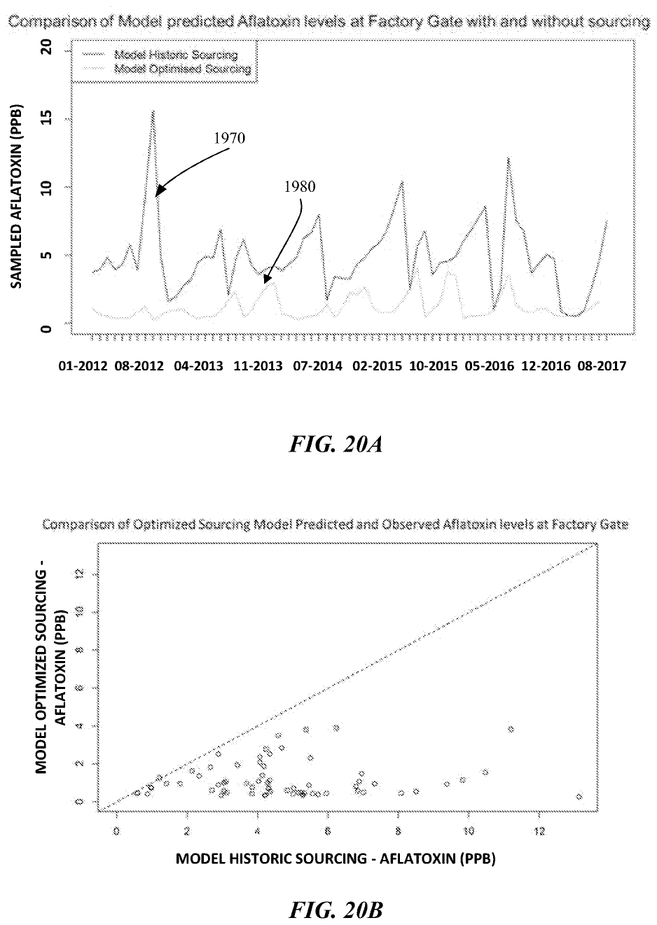

In FIG. 20A, the observed aflatoxin levels at the factory gate using historic sourcing (1970) are compared with the model predicted aflatoxin levels 1980 when using the model predicted optimal sourcing strategy. As shown, aflatoxin levels may be significantly reduced when optimally sourcing maize batches.

FIG. 20B shows a scatter plot for FIG. 20A. The model predicted optimal sourcing strategy was generated by running the model once and analyzing all available material available each month, then generating a sourcing strategy that sourced from the material with the lowest predicted aflatoxin each month. The model was then run again using this optimal sourcing strategy to generate the predicted aflatoxin levels under this strategy (FIG. 20A) It can be observed that the optimal sourcing strategy typically greatly reduces the observed levels of aflatoxin. The annual profile of aflatoxin levels, especially peak levels is significantly changed, with most of the highest peaks in aflatoxin levels being removed under the optimal sourcing strategy. In only 4 of the 70 months analyzed did historic sourcing match the performance of the optimal sourcing strategy. This aflatoxin profile acts as a lower bound-any alternative sourcing strategy could achieve aflatoxin levels up to those observed here. In particular embodiments, this aflatoxin profile can be combined with an economic analysis: while this sourcing strategy may provide the lowest achievable aflatoxin levels, it may be that a different sourcing strategy could achieve an acceptable level of aflatoxin reduction for a lower cost.

As described above, the model is able to replicate key features of the data and is overall fit. The model can easily scale and have periodicity. In addition, the model seems to fit rejection trends well, even though it was fitted to the aflatoxin amounts, not directly to rejection data. The model can help explain a lot of sources of variance.

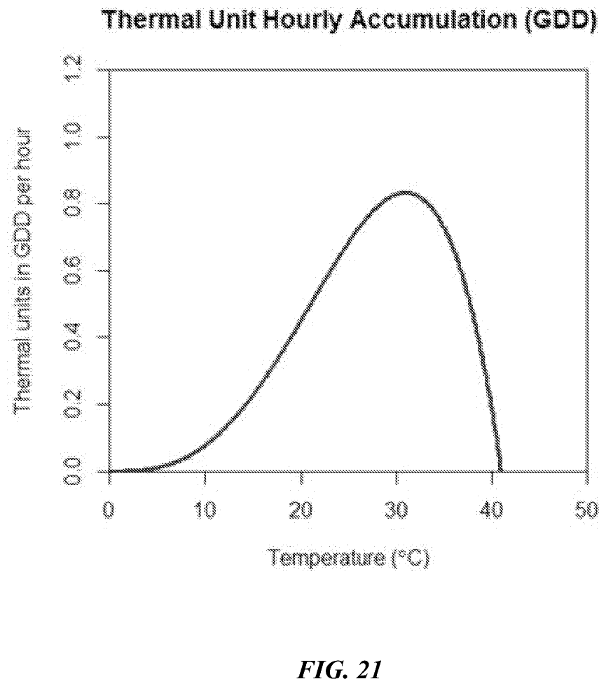

Table 5 summarizes maize growth phase in terms of growing degree days. FIG. 21 illustrates example hourly thermal unit accumulation in growing degree days (GDD).

TABLE 5
Maize growth phase in terms of growing degree days.

| | | Growing |
|---|---|---|
| | | Degree Days |
| Phase | Development Stage | (° C.) |
| Vegetative | Planting | 0 |
| | Two leaves fully emerged | 110 |
| | Four leaves fully emerged | 190 |
| | Six leaves fully emerged (Growing point | 260 |
| | above soil) | |
| | Eight leaves fully emerged (Tassel beginning | 340 |
| | to develop) | |
| | Ten leaves fully emerged | 410 |
| Reproductive | Twelve leaves fully emerged (Ear formation) | 480 |
| | Fourteen leaves fully emerged (Silks | 560 |
| | developing on ear) | |
| | Sixteen leaves fully emerged (Tip of tassel | 630 |
| | emerging) | |
| | Silks emerging/pollen shedding (Plant at full | 780 |
| | height) | |
| Maturation | Kernels in blister stage | 920 |
| | Kernels in dough stage | 1070 |
| | Kernels denting | 1220 |
| | Kernels dented | 1360 |
| | Physiological maturity | 1500 |

### Computing System

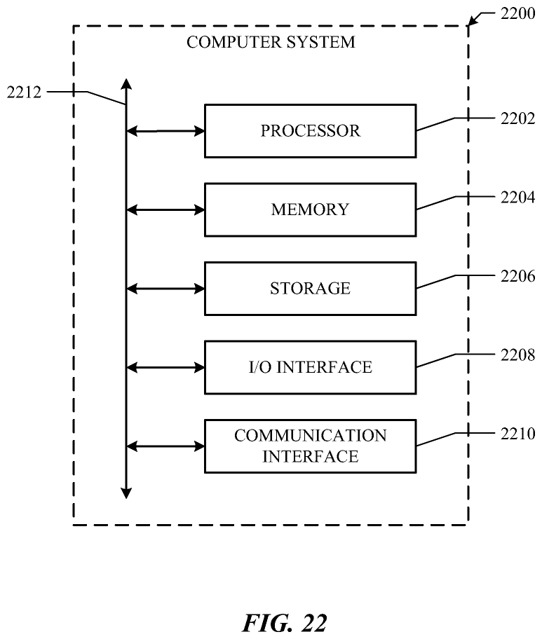

FIG. 22 illustrates an example computing system 2200. In particular embodiments, one or more computing systems 2200 perform one or more steps of one or more methods described or illustrated herein. In particular embodiments, one or more computing systems 2200 provide functionality described or illustrated herein. In particular embodiments, software running on one or more computing systems 2200 performs one or more steps of one or more methods described or illustrated herein or provides functionality described or illustrated herein. Particular embodiments include one or more portions of one or more computing systems 2200. Herein, reference to a computing system may encompass a computing device, and vice versa, where appropriate. Moreover, reference to a computing system may encompass one or more computing systems, where appropriate.

This disclosure contemplates any suitable number of computing systems 2200. This disclosure contemplates computing system 2200 taking any suitable physical form. As example and not by way of limitation, computing system 2200 may be an embedded computing system, a system-on-chip (SOC), a single-board computing system (SBC) (such as, for example, a computer-on-module (COM) or system-on-module (SOM)), a desktop computing system, a laptop or notebook computing system, an interactive kiosk, a mainframe, a mesh of computing systems, a mobile telephone, a personal digital assistant (PDA), a server, a tablet computing system, or a combination of two or more of these. Where appropriate, computing system 2200 may include one or more computing systems 2200; be unitary or distributed; span multiple locations; span multiple machines; span multiple data centers; or reside in a cloud, which may include one or more cloud components in one or more networks. Where appropriate, one or more computing systems 2200 may perform without substantial spatial or temporal limitation one or more steps of one or more methods described or illustrated herein. As an example and not by way of limitation, one or more computing systems 2200 may perform in real time or in batch mode one or more steps of one or more methods described or illustrated herein. One or more computing systems 2200 may perform at different times or at different locations one or more steps of one or more methods described or illustrated herein, where appropriate.

In particular embodiments, computing system 2200 includes a processor 2202, memory 2204, storage 2206, an input/output (I/O) interface 2208, a communication interface 2210, and a bus 2212. Although this disclosure describes and illustrates a particular computing system having a particular number of particular components in a particular arrangement, this disclosure contemplates any suitable computing system having any suitable number of any suitable components in any suitable arrangement.

In particular embodiments, processor 2202 includes hardware for executing instructions, such as those making up a computer program. As an example and not by way of limitation, to execute instructions, processor 2202 may retrieve (or fetch) the instructions from an internal register, an internal cache, memory 2204, or storage 2206; decode and execute them; and then write one or more results to an internal register, an internal cache, memory 2204, or storage 2206. In particular embodiments, processor 2202 may include one or more internal caches for data, instructions, or addresses. This disclosure contemplates processor 2202 including any suitable number of any suitable internal caches, where appropriate. As an example and not by way of limitation, processor 2202 may include one or more instruction caches, one or more data caches, and one or more translation lookaside buffers (TLBs). Instructions in the instruction caches may be copies of instructions in memory 2204 or storage 2206, and the instruction caches may speed up retrieval of those instructions by processor 2202. Data in the data caches may be copies of data in memory 2204 or storage 2206 for instructions executing at processor 2202 to operate on; the results of previous instructions executed at processor 2202 for access by subsequent instructions executing at processor 2202 or for writing to memory 2204 or storage 2206; or other suitable data. The data caches may speed up read or write operations by processor 2202. The TLBs may speed up virtual-address translation for processor 2202. In particular embodiments, processor 2202 may include one or more internal registers for data, instructions, or addresses. This disclosure contemplates processor 2202 including any suitable number of any suitable internal registers, where appropriate. Where appropriate, processor 2202 may include one or more arithmetic logic units (ALUs); be a multi-core processor; or include one or more processors 2202. Although this disclosure describes and illustrates a particular processor, this disclosure contemplates any suitable processor.

In particular embodiments, memory 2204 includes main memory for storing instructions for processor 2202 to execute or data for processor 2202 to operate on. As an example and not by way of limitation, computing system 2200 may load instructions from storage 2206 or another source (such as, for example, another computing system 2200) to memory 2204. Processor 2202 may then load the instructions from memory 2204 to an internal register or internal cache. To execute the instructions, processor 2202 may retrieve the instructions from the internal register or internal cache and decode them. During or after execution of the instructions, processor 2202 may write one or more results (which may be intermediate or final results) to the internal register or internal cache. Processor 2202 may then write one or more of those results to memory 2204. In particular embodiments, processor 2202 executes only instructions in one or more internal registers or internal caches or in memory 2204 (as opposed to storage 2206 or elsewhere) and operates only on data in one or more internal registers or internal caches or in memory 2204 (as opposed to storage 2206 or elsewhere). One or more memory buses (which may each include an address bus and a data bus) may couple processor 2202 to memory 2204. Bus 2212 may include one or more memory buses, as described below. In particular embodiments, one or more memory management units (MMUs) reside between processor 2202 and memory 2204 and facilitate accesses to memory 2204 requested by processor 2202. In particular embodiments, memory 2204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2204 may include one or more memories 2204, where appropriate. Although this disclosure describes and illustrates particular memory, this disclosure contemplates any suitable memory.

In particular embodiments, storage 2206 includes mass storage for data or instructions. As an example and not by way of limitation, storage 2206 may include a hard disk drive (HDD), a floppy disk drive, flash memory, an optical disc, a magneto-optical disc, magnetic tape, or a Universal Serial Bus (USB) drive or a combination of two or more of these. Storage 2206 may include removable or non-removable (or fixed) media, where appropriate. Storage 2206 may be internal or external to computing system 2200, where appropriate. In particular embodiments, storage 2206 is non-volatile, solid-state memory. In particular embodiments, storage 2206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2206 taking any suitable physical form. Storage 2206 may include one or more storage control units facilitating communication between processor 2202 and storage 2206, where appropriate. Where appropriate, storage 2206 may include one or more storages 2206. Although this disclosure describes and illustrates particular storage, this disclosure contemplates any suitable storage.

In particular embodiments, I/O interface 2208 includes hardware, software, or both, providing one or more interfaces for communication between computing system 2200 and one or more I/O devices. Computing system 2200 may include one or more of these I/O devices, where appropriate. One or more of these I/O devices may enable communication between a person and computing system 2200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2208 for them. Where appropriate, I/O interface 2208 may include one or more device or software drivers enabling processor 2202 to drive one or more of these I/O devices. I/O interface 2208 may include one or more I/O interfaces 2208, where appropriate. Although this disclosure describes and illustrates a particular I/O interface, this disclosure contemplates any suitable I/O interface.

In particular embodiments, communication interface 2210 includes hardware, software, or both providing one or more interfaces for communication (such as, for example, packet-based communication) between computing system 2200 and one or more other computing systems 2200 or one or more networks. As an example and not by way of limitation, communication interface 2210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2210 for it. As an example and not by way of limitation, computing system 2200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computing system 2200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computing system 2200 may include any suitable communication interface 2210 for any of these networks, where appropriate. Communication interface 2210 may include one or more communication interfaces 2210, where appropriate. Although this disclosure describes and illustrates a particular communication interface, this disclosure contemplates any suitable communication interface.

In particular embodiments, bus 2212 includes hardware, software, or both coupling components of computing system 2200 to each other. As an example and not by way of limitation, bus 2212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2212 may include one or more buses 2212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

While the disclosed subject matter is described herein in terms of certain preferred embodiments, those skilled in the art will recognize that various modifications and improvements can be made to the disclosed subject matter without departing from the scope thereof. Moreover, although individual features of one non-limiting embodiment of the disclosed subject matter can be discussed herein or shown in the drawings of the one non-limiting embodiment and not in other embodiments, it should be apparent that individual features of one non-limiting embodiment can be combined with one or more features of another embodiment or features from a plurality of embodiments.

1. A method comprising, by one or more computing systems:
obtaining meteorological data in time series associated with a selected region;
predicting an amount of A. flavus and aflatoxin contamination in the time series for a plurality of batches of crops using an integrated mechanistic model based on the meteorological data, wherein the integrated mechanistic model comprises estimated parameters and reference parameters, wherein the estimated parameters being optimized based on a comparison of a historical measured data set and a historical predicted data set; and
evaluating a decision of processing the plurality of batches of crops in the selected region based on the predicted amount of A. flavus and the predicted aflatoxin contamination.

2. The method of claim 1, wherein the integrated mechanistic model comprises mechanisms associated with a pre-harvest stage, a harvest processing stage, and a post-harvest stage.

3. The method of claim 1, wherein the meteorological data comprises temperature data, humidity data and rainfall data.

4. The method of claim 1, wherein the meteorological data has a temporal resolution of three hours and a spatial resolution of ten kilometers, with temporal data being linearly interpolated to a 1-hour temporal resolution.

5. The method of claim 1, wherein the historical measured data set comprises a first dataset being used for parameterizing the integrated mechanistic model, and a second dataset being used for validating the integrated mechanistic model.

6. The method of claim 1, wherein the estimated parameters comprise a sporulation rate, a pre-harvest A. flavus growth rate, a pre-harvest Aflatoxin production rate, a drying protection period, a post-harvest A. flavus growth rate, and a post-harvest Aflatoxin production rate.

7. One or more computer-readable non-transitory storage media embodying software that is operable when executed to:
obtain meteorological data in time series associated with a selected region;
predict an amount of A. flavus and aflatoxin contamination in the time series for a plurality of batches of crops using an integrated mechanistic model based on the meteorological data, wherein the integrated mechanistic model comprises estimated parameters and reference parameters, wherein the estimated parameters being optimized based on a comparison of a historical measured data set and a historical predicted data set; and
evaluate a decision of processing the plurality of batches of crops in the selected region based on the predicted amount of A. flavus and the predicted aflatoxin contamination.

8. The media of claim 7, wherein the integrated mechanistic model comprises mechanisms associated with a pre-harvest stage, a harvest processing stage, and a post-harvest stage.

9. The media of claim 7, wherein the meteorological data comprises temperature data, humidity data and rainfall data.

10. The media of claim 7, wherein the meteorological data has a temporal resolution of three hours and a spatial resolution of ten kilometers, with temporal data being linearly interpolated to a 1-hour temporal resolution.

11. The media of claim 7, wherein the historical measured data set comprises a first dataset being used for parameterizing the integrated mechanistic model, and a second dataset being used for validating the integrated the integrated mechanistic model.

12. The media of claim 7, wherein the estimated parameters comprise a sporulation rate, a pre-harvest A. flavus growth rate, a pre-harvest Aflatoxin production rate, a drying protection period, a post-harvest A. flavus growth rate, and a post-harvest Aflatoxin production rate.

13. (canceled)

14. (canceled)

15. (canceled)

16. (canceled)

17. (canceled)

18. (canceled)

19. A method comprising, by one or more computing systems:
obtaining input data, the input data including at least future meteorological data associated with a selected region;
predicting, based on the input data, an amount of aflatoxin contamination for a future time point for a plurality of batches of crops using a predicting model, the predicting model including parameters that are optimized based on a comparison of a historical measured data set and a historical predicted data set;
selecting a mitigating action for reducing the amount of aflatoxin contamination; and
performing the mitigating action.

20. The method of claim 19, wherein the selecting of the mitigating action for reducing the amount aflatoxin contamination is determined by minimizing a cost function.

21. The method of claim 20, wherein the cost function is selected such that the amount of aflatoxin contamination is reduced below a selected threshold value at the future time point.

22. The method of claim 21, wherein the cost function further includes a cost of performing the mitigating action.

23. The method of claim 21, wherein the cost function further includes a benefit for supporting agriculture at a particular region.

24. The method of claim 19, wherein the mitigating action include one of:
filtering, drying or bagging.

25. The method of claim 19, wherein the input data further includes farm-related data.

26. The method of claim 19, wherein the mitigating action is a first mitigating action, the method further comprising selecting a second mitigating action resulting in a further reduction of the amount of aflatoxin contamination.

27. (canceled)

28. (canceled)

29. (canceled)

30. (canceled)

31. (canceled)

32. (canceled)

33. (canceled)

34. (canceled)
